(19) United States
(12) Patent Application Publication
(10) Pub. No.: US 2016/0039389 A1
(43) Pub. Date: Feb. 11, 2016

(54) AIR BLOWING DEVICE

(71) Applicant: DENSO CORPORATION, Kariya-city, Aichi-pref. (JP)

(72) Inventors: Shinya KATO, Hekinan-city (JP); Toshinori OCHIAI, Obu-city (JP)

(21) Appl. No.: 14/781,784

(22) PCT Filed: Mar. 17, 2014
(86) PCT No.: PCT/JP2014/001490

§ 371 Date: Oct. 1, 2015

(30) Foreign Application Priority Data
Apr. 5, 2013 (JP) 2013-079701
Nov. 15, 2013 (JP) 2013-236867

(51) Int. Cl. B60S 1/02; B60H 1/34; B60S 1/54

(52) U.S. Cl. CPC B60S 1/023; B60S 1/544; B60H 1/3414

(57) ABSTRACT

An air blowing device includes a duct having an air path inside and an air outlet that blows air, and an air flow deflection member provided in the duct. The air path has one side path on one side and other side path on the other side, between which the air flow deflection member is located in the duct. The air flow deflection member is able to switch between a first state in which a high-speed air flow is provided in the one side path and a low-speed air flow is provided in the other side path by reducing a sectional area ratio of the one side path to be smaller than a sectional area ratio of the other side path and a second state in which an air flow differing from that of the first state is provided in the duct. A portion of the duct on the one side and adjacent to the air outlet has a guide wall to curve the high-speed air flow from the one side path along a wall surface of the guide wall.

### CROSS REFERENCE TO RELATED APPLICATION

This application is based on Japanese Patent Application No. 2013-79701 filed on Apr. 5, 2013 and Japanese Patent Application No. 2013-236867 filed on Nov. 15, 2013, the disclosures of which are incorporated herein by reference.

### TECHNICAL FIELD

The present disclosure relates to an air blowing device that blows off air to an air-conditioning target space.

### BACKGROUND ART

PTL 1 describes an air blowing device in which a defroster air outlet from which air is blown toward a windshield of a vehicle and an air outlet from which air is blown toward the vehicle interior are made common. The air blowing device includes a duct communicating with an air outlet, a guide wall provided on at least the vehicle interior side of a portion of the duct adjacent to the air outlet, a nozzle provided in the duct, and a control flow air outlet from which a control flow is blown off toward the upstream side of the nozzle in the air flow. The guide wall is curved in a convex form. The nozzle forms a high-speed air flow by throttling a main flow. The control flow air outlet is provided on both the vehicle front side and the vehicle rear side, and is configured in such a way that the control flow is blown out of only either one of the control flow air outlets.

In the air blowing device, switching of the direction in which air is blown from the air outlet is carried out by the control flow. That is, by the control flow being blown from the rear of the vehicle toward the front of the vehicle, the high-speed air flow from the nozzle is directed to the vehicle front side. Because of this, air is blown from the air outlet toward the windshield. Meanwhile, by the control flow being blown from the front of the vehicle toward the rear of the vehicle, the high-speed air flow from the nozzle is directed to the vehicle rear side. Because of this, the high-speed air flow is curved by flowing along the guide wall owing to the Coanda effect, and air is blown from the air outlet toward the vehicle interior.

### PRIOR ART LITERATURES

### Patent Literature

PTL 1: JP H01-027937 Y2

### SUMMARY OF INVENTION

However, the angle of curve of the air cannot be increased by the air blowing device because air is blown from the air outlet while being curved simply by the high-speed air flow being caused to follow the guide wall. Although the air blowing device of PTL 1 is applied to a vehicle defroster air outlet, the same applies to an air blowing device applied to another vehicle air outlet, or to an air outlet of an air conditioning device other than in a vehicle.

An object of the disclosure is to provide an air blowing device in which the direction in which air is blown from the air outlet can be switched, and the angle of curve can be increased when air is blown from the air outlet in the curved state.

According to an aspect of the present disclosure, an air blowing device includes an air outlet that blows air to a target space, a duct communicated with the air outlet and having an air path inside, and an air flow deflection member provided in the duct. The air path has one side path on one side and other side path on the other side, between which the air flow deflection member is located in the duct. The air flow deflection member is able to switch between a first state in which a high-speed air flow is provided in the one side path and a low-speed air flow is provided in the other side path by reducing a sectional area ratio of the one side path to be smaller than a sectional area ratio of the other side path and a second state in which an air flow differing from that of the first state is provided in the duct. A portion of the duct on the one side and adjacent to the air outlet duct has a guide wall to curve the high-speed air flow from the one side path along a wall surface of the guide wall.

Accordingly, the blowing direction of air blown from the air outlet can be change by switching between the first state and the second state using the air flow deflection member. In the first state, air flowing through the duct is curved to one side and blown from the air outlet as a high-speed air flow from the one side path flowing along the guide wall. In the second state, air flowing through the duct is blown from the air outlet without being curved to the one side, or after being curved to the one side at an angle of curve smaller than that in the first state.

In the disclosure, when in the first state, a negative pressure occurs on the downstream side of the air flow deflection member in the air flow due to the high-speed air flow provided in the one side path. Therefore, the low-speed air flow in the other side path is drawn to the downstream side of the air flow deflection member in the air flow, and the low-speed air flow mixes with the high-speed air flow while curving toward the high-speed air flow. Thus, when air flowing through the duct is curved to the one side and blown from the air outlet, the angle of curve can be increased, in comparison with a case in which a high-speed air flow is simply caused to follow a guide wall.

### BRIEF DESCRIPTION OF DRAWINGS

FIG. 1 is a schematic view showing an air blowing device and an air conditioning unit according to a first embodiment.

FIG. 2 is a schematic view showing the configuration of the air conditioning unit of FIG. 1.

FIG. 3 is an enlarged view of an air outlet and a duct of FIG. 1 when in a face mode.

FIG. 4 is an enlarged view of the air outlet and the duct of FIG. 1 when in a defroster mode.

FIG. 5 is an enlarged view of the air outlet and the duct of FIG. 1 when in the defroster mode.

FIG. 6 is a diagram showing an air conditioning unit of a comparison example mounted to a vehicle.

FIG. 7 is a schematic view showing an air flow from a face air outlet of the comparison example.

FIG. 8 is a schematic view showing an air flow from the air outlet of FIG. 1 when in the face mode.

FIG. 9 is a schematic view showing an air blowing device according to a second embodiment.

FIG. 10 is a graph showing the relationship between a door angle and a blow-off angle in the air blowing device of FIG. 9.

FIG. 11 is a schematic view showing an air blowing device according to a third embodiment.

FIG. 12 is a schematic view showing an air blowing device according to a fourth embodiment.

FIG. 13 is a schematic view showing an air blowing device according to a fifth embodiment.

FIG. 14 is a schematic view showing an air blowing device according to a sixth embodiment.

FIG. 15 is a schematic view showing an air blowing device according to a seventh embodiment.

FIG. 16 is a schematic view showing an air blowing device according to an eighth embodiment.

FIG. 17 is a schematic view showing an air blowing device according to a ninth embodiment.

FIG. 18 is a schematic view showing an air blowing device according to a tenth embodiment.

FIG. 19 is a schematic view showing an air blowing device according to an eleventh embodiment.

FIG. 20 is a schematic view showing an air blowing device according to a twelfth embodiment.

FIG. 21 is a perspective view of a vehicle interior front portion in which is mounted an air blowing device according to a thirteenth embodiment.

FIG. 22 is a perspective view of the air blowing device of the thirteenth embodiment.

FIG. 23 is a top view of a cover in FIG. 21.

FIG. 24 is a sectional view taken along a line XXIV-XXIV in FIG. 23.

FIG. 25 is a sectional view taken along a line XXV-XXV in FIG. 23.

FIG. 26 is an enlarged view of a region XXVI in FIG. 24.

FIG. 27 is a sectional view showing a modification of the thirteenth embodiment.

FIG. 28 is a sectional view showing the positional relationship between a cover and a guide wall of an air blowing device according to a fourteenth embodiment.

FIG. 29 is a perspective view showing an air blowing device according to a fifteenth embodiment.

FIG. 30 is a top view of a cover in FIG. 29.

FIG. 31 is a sectional view taken along a line XXXI-XXXI in FIG. 30.

FIG. 32 is a schematic view showing an air blowing device according to a sixteenth embodiment.

FIG. 33 is a diagram showing the interior of a duct in FIG. 32 seen from the upper side.

FIG. 34 is a sectional view taken along a line E-E in FIG. 32.

FIG. 35 is a sectional view taken along a line E-E in FIG. 32.

FIG. 36 is a sectional view taken along a line E-E in FIG. 32.

FIG. 37 is a block diagram showing an electrical control unit of the air blowing device of the sixteenth embodiment.

FIG. 38 is a top view showing the air blow-off direction from an air outlet when in a normal mode in the air blowing device of the sixteenth embodiment.

FIG. 39 is a sectional view taken along a line E-E in FIG. 32.

FIG. 40 is an air speed distribution diagram of air blown from the air outlet when in the normal mode in the air blowing device of the sixteenth embodiment.

FIG. 41 is an air speed distribution diagram at the position of an occupant when in the normal mode in the air blowing device of the sixteenth embodiment.

FIG. 42 is a top view showing the air blow-off direction of air blown from the air outlet when in an avoidance mode in the air blowing device of the sixteenth embodiment.

FIG. 43 is a top view showing the air blow-off direction of air blown from the air outlet when in a diffusion mode in the air blowing device of the sixteenth embodiment.

FIG. 44 is an air speed distribution diagram of air blown from the air outlet when in the diffusion mode in the air blowing device of the sixteenth embodiment.

FIG. 45 is an air speed distribution diagram at the position of an occupant when in the diffusion mode in the air blowing device of the sixteenth embodiment.

FIG. 46 is a schematic view showing an air blowing device according to a modification of the sixteenth embodiment.

FIG. 47 is a top view showing the air blow-off direction of air blown from an air outlet when in the diffusion mode in the air blowing device of the modification of the sixteenth embodiment.

FIG. 48 is a top view showing the air blow-off direction of air blown from the air outlet when in a concentration mode in the air blowing device of the sixteenth embodiment.

FIG. 49 is an air speed distribution diagram of air blown from the air outlet when in the concentration mode in the air blowing device of the sixteenth embodiment.

FIG. 50 is an air speed distribution diagram at the position of an occupant when in the concentration mode in the air blowing device of the sixteenth embodiment.

FIG. 51 is a schematic view showing an air blowing device according to a seventeenth embodiment.

FIG. 52 is a schematic view showing an air blowing device according to an eighteenth embodiment.

FIG. 53 is a schematic view showing an air blowing device according to a nineteenth embodiment.

FIG. 54 is a schematic view showing an air blowing device according to a twentieth embodiment.

FIG. 55 is a schematic view showing the air blowing device of the twentieth embodiment.

FIG. 56 is a perspective view showing an air blowing device according to other embodiment.

FIG. 57 is a diagram showing a cover and the interior of a duct in FIG. 56 seen from the upper side.

### DESCRIPTION OF EMBODIMENTS

Hereafter, based on the drawings, embodiments of the disclosure will be described. The following embodiments will be described with portions the same as, or equivalent to, each other given the same reference signs.

### First Embodiment

In this embodiment, an air blowing device according to the disclosure is applied to an air outlet and a duct of an air conditioning unit mounted in the front of a vehicle.

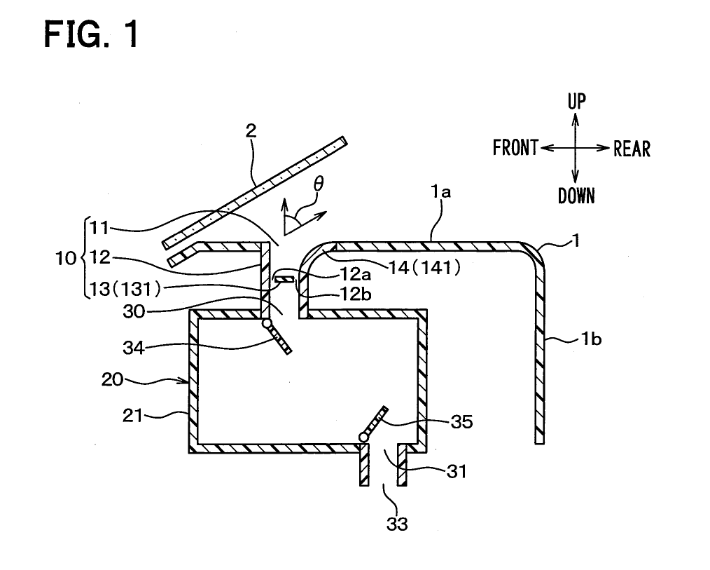

As shown in FIG. 1, an air blowing device 10 includes an air outlet 11 defined in an upper face 1a of an instrument panel 1 and provided adjacent to a windshield 2, a duct 12 that connects the air outlet 11 and an air conditioning unit 20, and an air flow deflection door 13 disposed inside the duct 12.

The air outlet 11 blows out temperature-regulated air, switching between three blowing modes, those being a defroster mode, an upper vent mode, and a face mode, using the air flow deflection door 13. The defroster mode is a blowing mode in which air is blown toward the windshield 2, thereby clearing misting of the window. The face mode is a blowing mode in which air is blown toward the upper body of an occupant on a front seat. The upper vent mode is a blowing mode in which air is blown further upward than when in the face mode, thereby feeding air to an occupant on a rear seat.

The air outlet 11 has a form extending to elongate in the vehicle width direction, and is disposed across the front of the driver seat and the front of the front passenger seat. The length of the air outlet 11 in the vehicle width direction, and the place of the air outlet 11 in the upper face 1a can be changed arbitrarily. The air outlet 11 is defined by an end aperture portion of the duct 12.

The duct 12 provides an air flow path along which air fed from the air conditioning unit 20 flows. The duct 12 is a resin component configured as a body separate from the air conditioning unit 20, and is connected to the air conditioning unit 20. The duct 12 communicates with a defroster/face aperture portion 30 of the air conditioning unit 20. The duct 12 may be configured integrally with the air conditioning unit 20.

The air flow deflection door 13 is an air flow deflection member that changes flow direction and speed of air in the duct 12. In other words, the air flow deflection door 13 causes the air flow speed of the front side path 12a and the air flow speed of the rear side path 12b to differ by changing the ratio between the sectional area of the front side path 12a and the sectional area of the rear side path 12b in the duct 12. The front side path 12a is defined on the vehicle front side with respect to the air flow deflection door 13, and the rear side path 12b is defined on the vehicle rear side with respect to the air flow deflection door 13. In this embodiment, the rear side path 12b on the vehicle rear side corresponds to one side path, and the front side path 12a on the vehicle front side corresponds to the other side path.

In this embodiment, a sliding door 131 capable of sliding to the vehicle front side and the vehicle rear side is employed as the air flow deflection door 13. The length of the sliding door 131 in the vehicle front-rear direction is less than the width of the duct 12 in the vehicle front-rear direction, such that the front side path 12a and the rear side path 12b can be provided. By sliding in the front-rear direction, the sliding door 131 can switch between a first state in which a high-speed air flow (air blast) is provided in the rear side path 12b and a low-speed air flow is provided in the front side path 12a, and a second state in which an air flow differing from that of the first state is provided in the duct 12.

A wall of the duct 12 on the vehicle rear side of the air outlet 11 includes a guide wall 14. The guide wall 14 seamlessly continues the upper face 1a of the instrument panel 1. The guide wall 14 guides a high-speed air flow along the wall surface to the vehicle rear side. The guide wall 14 has a form to increase the width of the air path of the duct 12 as extending from the air outlet 11 toward the downstream side in the air flow. In this embodiment, a guide wall 141 having a wall surface curved in a convex form is employed as the guide wall 14.

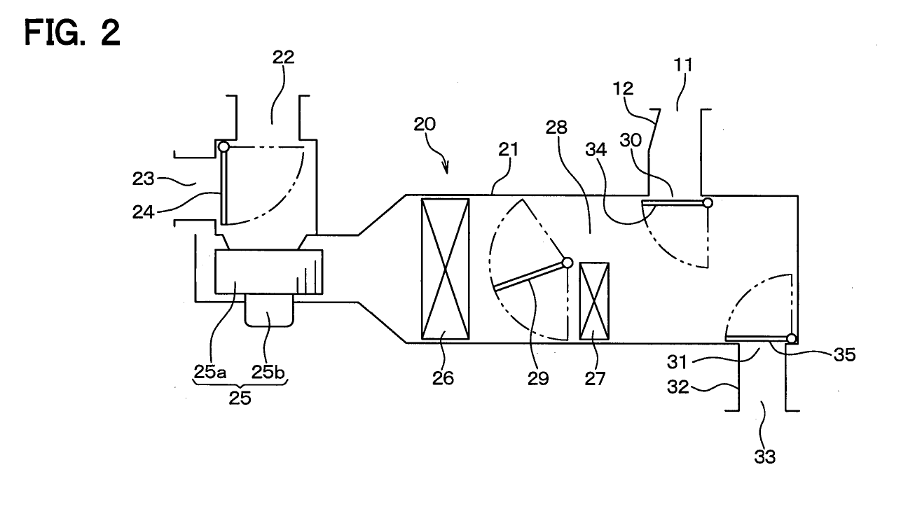

The air conditioning unit 20 is disposed in the instrument panel 1 located in front of the front seat in the vehicle interior. As shown in FIG. 2, the air conditioning unit 20 has an air conditioner casing 21 configuring an outer shell. The air conditioner casing 21 configures an air passage that leads air to the vehicle interior, which is an air conditioning target space. An internal air suction port 22 that takes in vehicle interior air (internal air) and an external air suction port 23 that takes in vehicle exterior air (external air), and a suction port switching door 24 that selectively opens and closes the suction ports 22 and 23, are provided at an upstream portion of the air conditioner casing 21 in the air flow. The internal air suction port 22, the external air suction port 23, and the suction port switching door 24 configure an internal/external air switching unit that switches air taken into the air conditioner casing 21 between internal air and external air. Operation of the suction port switching door 24 is controlled by a control signal output from a control device (not shown).

An air blower 25 acting as an air feed unit that feeds air to the vehicle interior is disposed on the downstream side of the suction port switching door 24 in the air flow. The air blower 25 of this embodiment is an electric air blower in which a centrifugal multi-blade fan (sirocco fan) 25a is driven by an electric motor 25b, which is a drive source. The rotation speed (amount of air fed) of the air blower 25 is controlled by a control signal output from a control device (not shown).

An evaporator 26 functioning as a cooling unit that cools air fed by the air blower 25 is disposed on the downstream side of the air blower 25 in the air flow. The evaporator 26 is a heat exchanger that causes an exchange of heat between refrigerant flowing through the evaporator 26 and the fed air, and configures a vapor compression type refrigerating cycle together with a compressor, a condenser, an expansion valve (which are not shown), and the like.

A heater core 27 functioning as a heating unit that heats air cooled by the evaporator 26 is disposed on the downstream side of the evaporator 26 in the air flow. The heater core 27 of this embodiment is a heat exchanger that heats air, with a coolant of the vehicle engine as a heat source. The evaporator 26 and the heater core 27 configure a temperature regulating unit that regulates the temperature of air blown to the vehicle interior.

A cold air bypass passage 28 that causes air after passing through the evaporator 26 to flow detouring the heater core 27 is provided on the downstream side of the evaporator 26 in the air flow.

The temperature of fed air mixed on the downstream side of the heater core 27 and the cold air bypass passage 28 in the air flow changes in accordance with the ratio between the amount of fed air passing through the heater core 27 and the amount of fed air passing through the cold air bypass passage 28.

An air mixing door 29 is disposed on the downstream side of the evaporator 26 in the air flow, and is located on the inlet side of the heater core 27 and the cold air bypass passage 28. The air mixing door 29 continuously changes the ratio between the amount of air flowing into the heater core 27 and the amount of air flowing into the cold air bypass passage 28, and functions as a temperature regulating unit together with the evaporator 26 and the heater core 27. Operation of the air mixing door 29 is controlled by a control signal output from a control device.

The defroster/face aperture portion 30 and a foot aperture portion 31 are provided at a downstream portion of the air conditioner casing 21 in the air flow. The defroster/face aperture portion 30 communicates with the air outlet 11 provided in the upper face 1a of the instrument panel 1 via the duct 12. The foot aperture portion 31 communicates with a foot air outlet 33 via a foot duct 32.

A defroster/face door 34 that opens and closes the defroster/face aperture portion 30 and a foot door 35 that opens and closes the foot aperture portion 31 are disposed on the upstream side of the aperture portions 30 and 31 in the air flow, respectively. The defroster/face door 34 and the foot door 35 are blowing mode doors that switch the state of air blown to the vehicle interior.

The air flow deflection door 13 is configured to operate in conjunction with the blowing mode doors 34 and 35 in order to switch to the required blowing mode. Operation of the air flow deflection door 13 and the blowing mode doors 34 and 35 is controlled by a control signal output from a control device. The positions of the air flow deflection door 13 and the blowing mode doors 34 and 35 can also be changed by a manual operation by an occupant.

For example, when a foot mode is executed as the blowing mode, air is blown toward the feet of an occupant from the foot air outlet 33, the defroster/face door 34 closes the defroster/face aperture portion 30, and the foot door 35 opens the foot aperture portion 31. When any one of the defroster mode, the upper vent mode, or the face mode is executed as the blowing mode, the defroster/face door 34 opens the defroster/face aperture portion 30, and the foot door 35 closes the foot aperture portion 31. In this case, the position of the air flow deflection door 13 is set in accordance with the required blowing mode.

In this embodiment, as described below, the position of the air flow deflection door 13 is changed by moving the air flow deflection door 13 in the front-rear direction, thereby changing the air flow velocities of the front side path 12a and the rear side path 12b, and changing a blowing angle θ. The blowing angle θ referred to here is, as shown in FIG. 1, an angle defined by the blowing direction with respect to the vertical direction. Herein, the vertical direction is taken as a reference because the direction of blowing air from the air outlet 11 is the vertical direction when there is no air flow deflection door 13 provided in the duct 12.

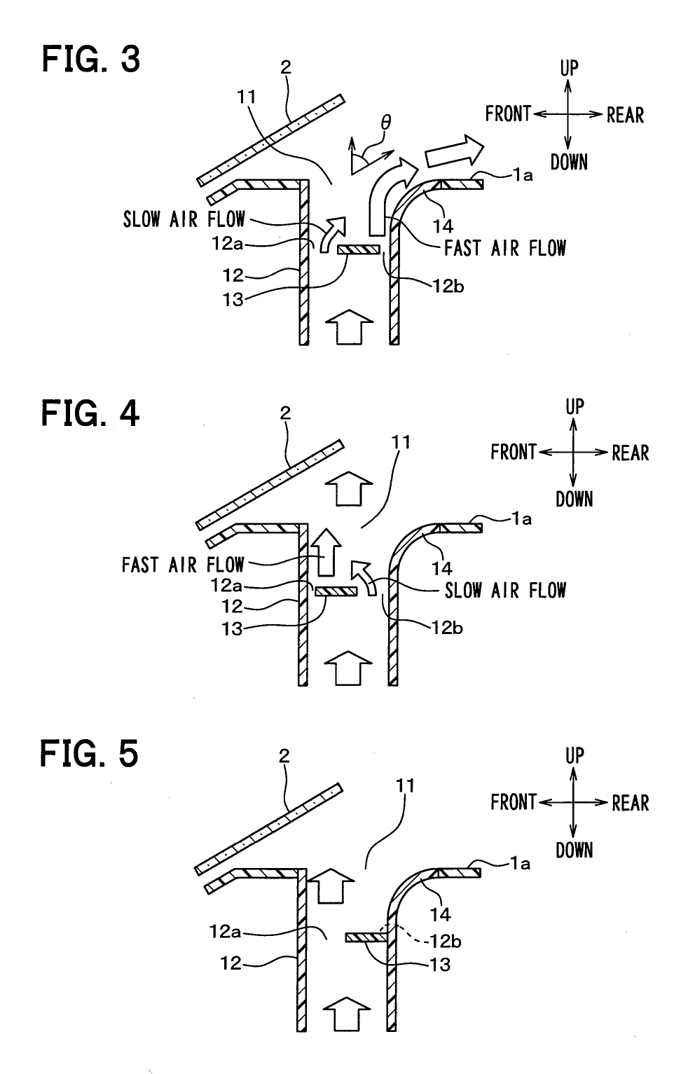

As shown in FIG. 3, when the blowing mode is the face mode, the air flow deflection door 13 is positioned on the vehicle rear side in order that the ratio of the sectional area of the rear side path 12b is relatively small while the ratio of the sectional area of the front side path 12a is relatively large. Because of this, the first state is in effect, such that a high-speed air flow is provided in the rear side path 12b and that a low-speed air flow is provided in the front side path 12a. The high-speed air flow is curved to the vehicle rear side by flowing along the guide wall 14 owing to the Coanda effect. As a result, air conditioned in the air conditioning unit 20, for example, cold air is blown from the air outlet 11 toward the upper body of an occupant. At this time, the blowing angle θ in the face mode can be controlled to an arbitrary angle by automatically changing the position of the air flow deflection door 13 with a control device or by manually adjusting by an occupant so as to adjust the speed ratio between the high-speed air flow and the low-speed air flow.

As shown in FIG. 4, when the blowing mode is the defroster mode, the air flow deflection door 13 is positioned on the vehicle front side in order that the ratio of the sectional area of the front side path 12a is relatively small while the ratio of the sectional area of the rear side path 12b is relatively large. Because of this, a second state differing from the first state is in effect. That is, a high-speed air flow is provided in the front side path 12a and a low-speed air flow is provided in the rear side path 12b. The high-speed air flow flows upward along the vehicle front side wall of the duct 12. As a result, air conditioned in the air conditioning unit 20, for example, warm air is blown from the air outlet 11 toward the windshield 2. At this time, the blowing angle in the defroster mode can be controlled to an arbitrary angle by automatically changing the position of the air flow deflection door 13 with a control device or by manually adjusting by an occupant so as to adjust the speed ratio between the high-speed air flow and the low-speed air flow.

When the blowing mode is the upper vent mode, the air flow deflection door 13 is positioned between the position of the air flow deflection door 13 in the face mode and the position of the air flow deflection door 13 in the defroster mode. While the first state is in effect in this case too, the blowing angle θ is smaller than in the case of the face mode because the high-speed air flow is slower than in the case of the face mode. As a result, air conditioned in the air conditioning unit 20, for example, cold air is blown from the air outlet 11 toward a rear seat occupant.

In this way, the upper vent mode is realized by controlling the ratio between the sectional area of the rear side path 12b and the sectional area of the front side path 12a with the air flow deflection door 13 so as to control the speed ratio between the high-speed air flow and the low-speed air flow with respect to the face mode. Also, when in the upper vent mode too, the blowing angle can be controlled to an arbitrary angle by automatically changing the position of the air flow deflection door 13 with a control device or by manually adjusting by an occupant so as to adjust the speed ratio between the high-speed air flow and the low-speed air flow.

When the blowing mode is the defroster mode, the air flow deflection door 13 may be positioned at a position shown in FIG. 5. In FIG. 5, the air flow deflection door 13 is positioned such that the rear side path 12b is fully closed and that the front side path 12a is fully open. In this case too, a second state differing from the first state is in effect. That is, air flows only along the front side path 12a and no high-speed air flow is provided in the rear side path 12b. Because of this, warm air is blown from the air outlet 11 toward the windshield 2. Also, the air flow deflection door 13 may be positioned such that the front side path 12a is fully closed and that the rear side path 12b is fully open, which is the reverse of the position shown in FIG. 5. In this case too, a second state differing from the first state is in effect. That is, air flows only along the rear side path 12b and no high-speed air flow is provided in the front side path 12a. Because of this, warm air is blown from the air outlet 11 toward the windshield 2.

Advantages of this embodiment will be described.

In a conventional air blowing device, the high-speed air flow is curved simply by a high-speed air flow (air blast) from a nozzle being caused to follow a guide wall, thereby changing the direction in which air is blown from an air outlet. Because of this, the air cannot be greatly curved when in the face mode, meaning that air cannot be blown toward the upper body of a front seat occupant.

In contrast, according to this embodiment, a high-speed air flow is provided in the rear side path 12b and a low-speed air flow is provided in the front side path 12a when in the face mode. At this time, a negative pressure occurs on the downstream side of the air flow deflection door 13 due to the high-speed air flow flowing. Because of this, the low-speed air flow is drawn to the downstream side of the air flow deflection door 13, and mixes with the high-speed air flow while being curved to the high-speed air flow side. Because of this, in comparison with PTL 1, the maximum angle of curve θ can be increased when air flowing through the duct 12 is curved to the vehicle rear side and blown from the air outlet 11, such that air can be blown toward the upper body of a front seat occupant.

In the conventional air blowing device, the orientation of the high-speed air flow is changed by a control flow blown from a control flow air outlet. Because of this, it is necessary to blow off air in a slit state uniform in the vehicle width direction from the control flow air outlet in order that the blowing direction of air from the air outlet is made uniform in the vehicle width direction. However, it is difficult to blow air in a slit state uniform in the vehicle width direction. So, it is difficult to make the orientation of the high-speed air flow uniform in the vehicle width direction and to make the blow direction of air from the air outlet uniform in the vehicle width direction.

In contrast, according to this embodiment, the position of the high-speed air flow is changed mechanically by the air flow deflection door 13 rather than by a control flow. Therefore, the high-speed air flow can be blown uniformly in the vehicle width direction. In comparison with PTL 1, the blow direction of air from the air outlet 11 can be easily made uniform in the vehicle width direction.

In this embodiment, when in the face mode, the air blowing angle θ is increased by controlling the ratio of the sectional area of the rear side path 12b to be smaller than the ratio of the sectional area of the front side path 12a. Thus, air is blown toward the vehicle rear from the upper face 1a of the instrument panel 1. As mainly cold air is used in the face mode, the air flow blown out is cold with respect to room temperature, and the air flow blown to the vehicle rear travels downward due to the difference in density. Because of this, there is an advantage in that the blowing angle θ can be further increased.

Meanwhile, when in the defroster mode, the air blowing angle θ is reduced by controlling the ratio of the sectional area of the front side path 12a to be smaller than the ratio of the sectional area of the rear side path 12b. Thus, air is blown upward from the upper face 1a of the instrument panel 1. As mainly warm air is used in the defroster mode, the air flow blown out is warm with respect to room temperature, and there is an advantage in that the air flow blown upward is unlikely to travel downward due to the difference in density.

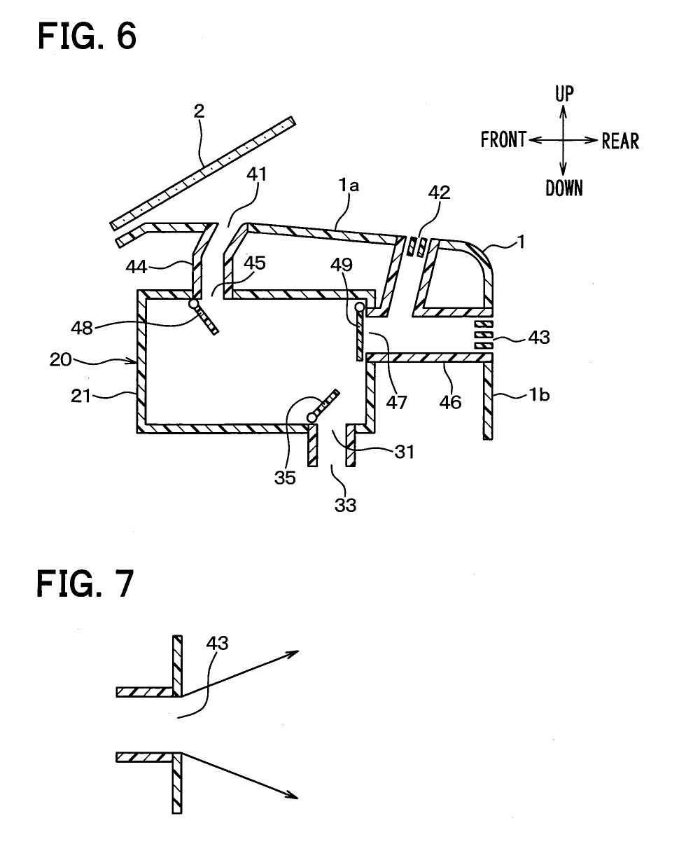

As shown in FIG. 6, a defroster air outlet 41, an upper vent air outlet 42, and a face air outlet 43 have been necessary to date in order to execute each of three blowing modes, those being a defroster mode, an upper vent mode, and a face mode. In this case, the defroster air outlet 41 is connected via a defroster duct 44 to a defroster aperture portion 45 provided in an air conditioner casing 21. The upper vent air outlet 42 and the face air outlet 43 are connected via a face duct 46 to a face aperture portion 47 provided in the air conditioner casing 21. Also, air outlet mode doors 48 and 49, which open and close the defroster aperture portion 45 and the face aperture portion 47, are provided in the air conditioner casing 21.

In contrast, according to this embodiment, a defroster air outlet, an upper vent air outlet, and a face air outlet are integrated in the one air outlet 11. Because of this, in comparison with the conventional device shown in FIG. 6, the number of ducts, the number of air outlet aperture portions provided in the air conditioner casing 21, and the number of air outlet mode doors that open and close the aperture portions can be reduced. As a result, the air conditioning unit 20 and the ducts can be simplified, and costs can thus be reduced.

In the conventional device shown in FIG. 6, the face air outlet 43 is provided in a design face 1b of an instrument panel 1. In contrast, according to this embodiment, the face air outlet in the design face 1b of the instrument panel 1 can be eliminated. Because of this, an improvement in the design of the instrument panel 1, a reduction in size, and an increase in storage space can be achieved. Furthermore, according to this embodiment, the air outlet 11 can be rendered difficult for an occupant to see because the air outlet 11 is provided in the upper face 1a of the instrument panel 1.

In the conventional device shown in FIG. 6, the face air outlet 43 is provided in the design face 1b of the instrument panel 1. Because of this, the installation range of the face air outlet 43 is limited by the steering wheel, the meters, and the like. The aperture area of the face air outlet is small, and an air flow from the air outlet is of a spotted form. As opposed to this, according to this embodiment, the aperture area of the air outlet 11 can be increased in comparison with the face air outlet 43 of the conventional device shown in FIG. 6, because the air outlet 11 is provided in the upper face 1a of the instrument panel 1. Thus, the speed of air blown from the air outlet 11 can be suppressed, and spotted air flow can be reduced.

In the conventional device shown in FIG. 6, as the steering wheel and the speed meter are disposed in front of the driver, the face air outlet 43 is disposed on the left or right side of the steering wheel such that air cannot be fed from directly in front of the driver. As opposed to this, according to this embodiment, air blown from the upper face 1a of the instrument panel 1 can be fed directly in front of the driver when in the face mode. Thus, cooling efficiency can be increased at a cooling time.

According to this embodiment, the defroster blowing angle can be changed by moving the air flow deflection door 13 when in the defroster mode. Because of this, the time taken to clear the window can be reduced by changing the defroster blowing angle with a manual operation by an occupant or an automatic operation by a control device when in the defroster mode.

In the conventional device shown in FIG. 6, an air flow blown from the face air outlet 43 is affected by ambient air above and below immediately after being blown out. In other words, ambient air above and below is mixed into an air flow blown from the face air outlet 43. Because of this, an air flow blown from the face air outlet 43 flows rearward while diffusing in upward and downward directions, as shown in FIG. 7.

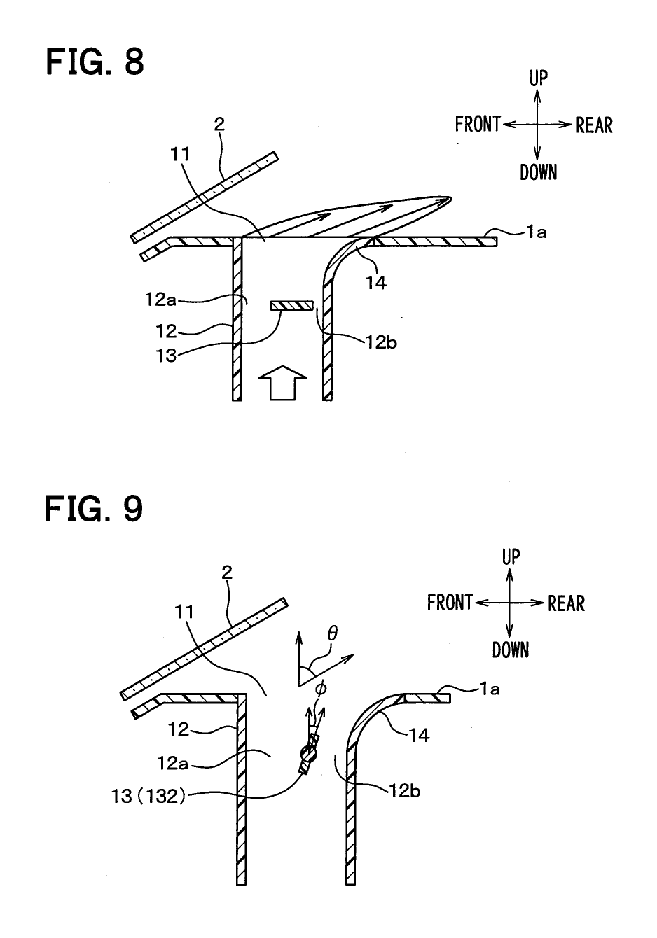

As opposed to this, in this embodiment, a low-speed air flow provided in the front side path 12a is drawn to the high-speed air flow provided in the rear side path 12b, such that the air flows concentrate when in the face mode, as already described. Because of this, an air flow flowing rearward from the air outlet 11 is restricted from diffusing to the upper side, as shown in FIGS. 3 and 8.

In general, an air flow with a high speed is liable to be affected by ambient air. According to this embodiment, as shown in FIG. 8, the upper face 1a of the instrument panel 1 is in the vicinity of a high-speed air flow blown from the air outlet 11. In FIG. 8, the longer arrow means air flow with a speed higher than the shorter arrow. Furthermore, in this embodiment, owing to the Coanda effect, a downward force works on the air flow to cause the air flow to follow the upper face 1a of the instrument panel 1. Because of this, an air flow flowing rearward from the air outlet 11 is restricted from diffusing to the lower side.

### Second Embodiment

In this embodiment, a butterfly door 132 is employed as an air flow deflection door 13, as shown in FIG. 9. The butterfly door 132 includes a plate-form door main body portion, and a rotating shaft provided in a central portion of the door main body portion. The length in the vehicle front-rear direction of the door main body portion is smaller than the width of a duct 12 in the vehicle front-rear direction. Because of this, the duct 12 is not closed even when the butterfly door 132 is horizontal. The rotating shaft is positioned on the vehicle rear side with respect to the center in the vehicle front-rear direction of the duct 12. This is in order to reduce the sectional area of a rear side path 12b, thus providing a high-speed air flow in the rear side path 12b.

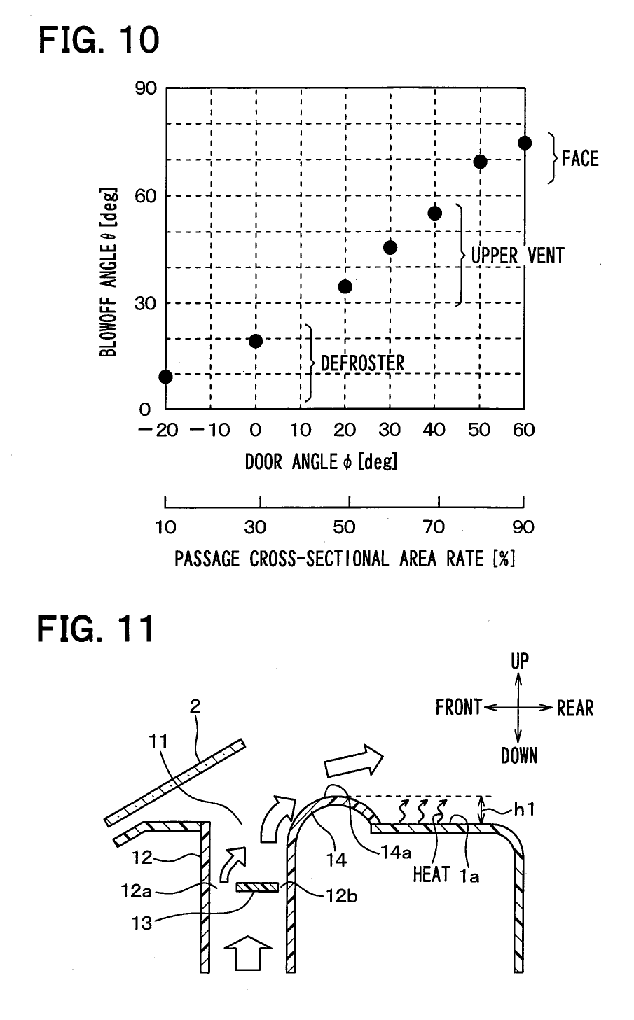

Herein, results of the investigation by the inventors are shown in FIG. 10 as to the relationship between a door angle φ of the butterfly door 132 and a blow-off angle θ of air blown from an air outlet 11. The door angle φ on the horizontal axis represents the angle formed by the door main body portion with respect to the vertical direction, as shown in FIG. 9. The door angle φ has a positive value when the angle is formed on the vehicle rear side with respect to the vertical direction. The ratio of the sectional area of a front side path 12a in accordance with the door angle φ is also shown on the horizontal axis. When subtracting the ratio of the sectional area of the front side path 12a from 100%, the remaining portion is the ratio of the sectional area of the rear side path 12b. The blow-off angle θ on the vertical axis represents the angle formed by the air blow direction with respect to the vertical direction, as shown in FIG. 9.

As shown in FIG. 10, when the door angle φ is increased, the blow-off angle θ increases. Specifically, when the door angle φ is −20 degrees, the ratio of the sectional area of the front side path 12a is 10%, and the blow-off angle θ is 10 degrees. When the door angle φ is 0 degrees, the ratio of the sectional area of the front side path 12a is 30%, and the blow-off angle θ is 20 degrees. Therefore, the defroster mode can be set in a range where the door angle φ is roughly −20 to 0 degrees. When the door angle φ is 20, 30, 40 degrees, the ratio of the sectional area of the front side path 12a is 50, 60, 70% respectively, and the blow-off angle θ is 35, 45, 55 degrees respectively. Therefore, the upper vent mode can be set in a range where the door angle φ is roughly 20 to 40 degrees. When the door angle φ is 50, 60 degrees, the ratio of the sectional area of the front side path 12a is 80, 90% respectively, and the blow-off angle θ is 70, 75 degrees respectively. Therefore, the face mode can be set in a range where the door angle φ is roughly 50 to 60 degrees.

Further, the blowing direction can be adjusted in the up-down direction by adjusting the door angle φ when in each blowing mode. While FIG. 10 shows the relationship between the door angle φ and the blow-off angle θ when using the butterfly door 132, it is presumed that the relationship between the sectional area ratio and the blowing angle θ in the first embodiment using the sliding door 131 has the same relationship as that of FIG. 10.

### Third Embodiment

In this embodiment, as shown in FIG. 11, a guide wall 14 is raised and projected from an upper face (general face) 1a of an instrument panel 1. Because of this, an uppermost portion 14a of the guide wall 14 is at a position with a height h1 from the upper face 1a of the instrument panel 1.

If the uppermost portion 14a of the guide wall 14 is at a position with the same height as the upper face 1a of the instrument panel 1, unlike in this embodiment, an air flow blown from an air outlet 11 flows in proximity to the upper face 1a of the instrument panel 1 when in the face mode. Normally, cold air is blown out in the face mode. However, when the upper face 1a of the instrument panel 1 is warmed by sunlight, the cold air is warmed by heat radiating from the upper face 1a of the instrument panel 1.

As opposed to this, in this embodiment, the uppermost portion 14a of the guide wall 14 is in a position higher than the upper face 1a of the instrument panel 1. When in the face mode, an air flow blown from the air outlet 11 flows approximately horizontally through a space on the upper side of the uppermost portion 14a of the guide wall 14. That is, according to this embodiment, an air flow blown from the air outlet 11 can be distanced from the upper face 1a of the instrument panel 1 when in the face mode. Because of this, cold air can be restricted from being warmed by heat radiating from the upper face 1a of the instrument panel 1.

### Fourth Embodiment

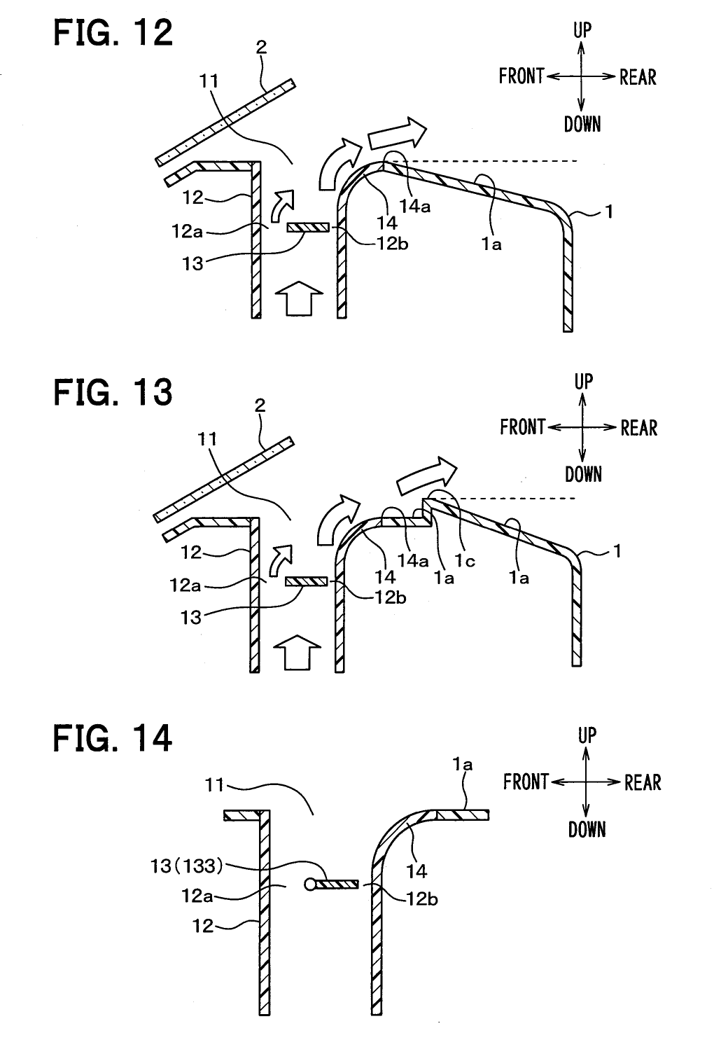

In this embodiment, as shown in FIG. 12, an upper face 1a of an instrument panel 1 is inclined to become gradually lower from an air outlet 11 toward the vehicle rear side. Because of this, an uppermost portion 14a of a guide wall 14 is in a position higher than the upper face 1a of the instrument panel 1. Thus, according to this embodiment too, the same advantage as in the third embodiment is obtained.

### Fifth Embodiment

In this embodiment, as shown in FIG. 13, an upper face 1a of an instrument panel 1 has a step portion 1c, and the upper face 1a is raised by the step portion 1c. Because of this, an uppermost portion 14a of a guide wall is in a position lower than the uppermost portion of the step portion 1c. A region of the upper face 1a on the vehicle front side with respect to the step portion 1c is in a position at the same height as the uppermost portion 14a of the guide wall 14. Meanwhile, a region of the upper face 1a on the vehicle rear side with respect to the step portion 1c is inclined to become gradually lower toward the vehicle rear side. The height of the step portion 1c is set to a height such that an air flow blown from an air outlet 11 can pass over the step portion 1c when in the face mode. Because of this, in this embodiment, an air flow blown from the air outlet 11 flows approximately horizontally while passing over the step portion 1c when in the face mode.

According to this embodiment, a region of the upper face 1a on the vehicle rear side with respect to the step portion 1c is inclined to become gradually lower toward the vehicle rear side. Therefore, an air flow blown from the air outlet 11 can be distanced from the upper face 1a of the instrument panel 1 when in the face mode. As a result, the same advantage as in the third embodiment is obtained.

In this way, even when the uppermost portion 14a of the guide wall 14 is in a position lower than the upper face 1a of the instrument panel 1, an air flow blown from the air outlet 11 can be distanced from the upper face 1a of the instrument panel 1, when in the face mode, provided that the upper face 1a of the instrument panel 1 becomes gradually lower toward the vehicle rear side. While the upper face 1a of the instrument panel 1 is a flat inclined face in the fourth and fifth embodiments, it is not essential that the upper face 1a is a flat inclined face. For example, a step portion (irregularity) may be provided while the upper face 1a of the instrument panel 1 gradually extends downward from the horizontal as extending rearward. Accordingly, when in the face mode, an air flow blown from the air outlet 11 flows approximately horizontally through a space on the upper side of the upper face 1a of the instrument panel 1. Thus, the air flow blown out can be distanced from the upper face 1a of the instrument panel 1.

### Sixth Embodiment

In this embodiment, as shown in FIG. 14, a cantilever door 133 is employed as an air flow deflection door 13. The cantilever door 133 includes a plate-form door main body portion, and a rotating shaft provided at one end of the door main body portion. The length of the door main body portion in the vehicle front-rear direction is smaller than the width of a duct 12 in the vehicle front-rear direction. Therefore, the duct 12 is not closed even when the cantilever door 133 is horizontal. According to this embodiment too, the same advantages as in the first embodiment are obtained.

### Seventh Embodiment

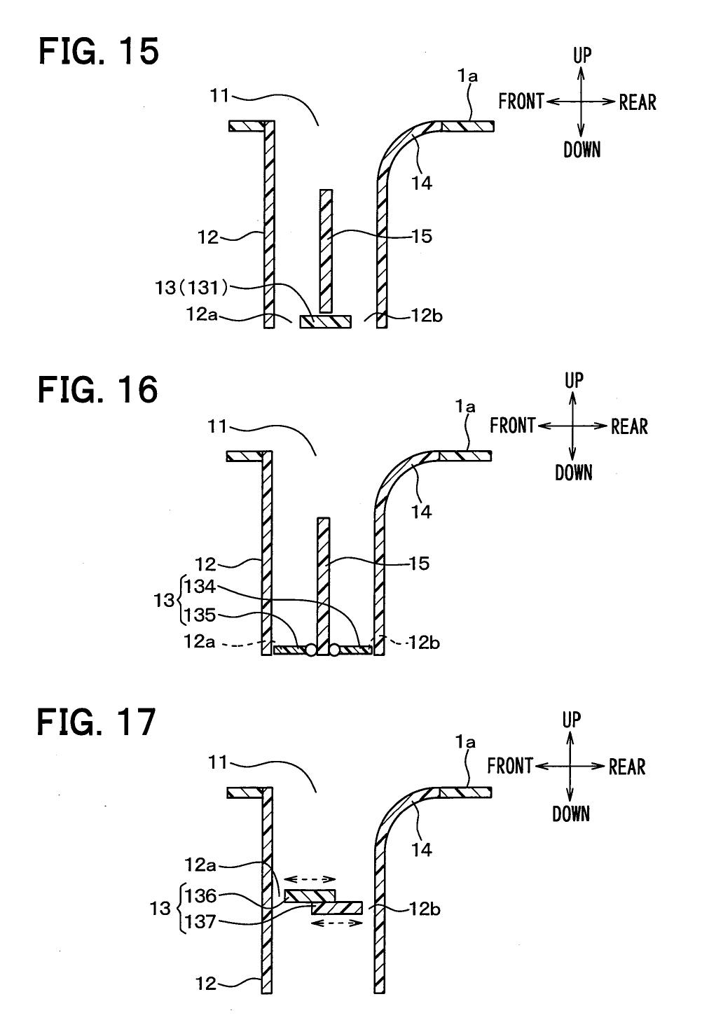

In this embodiment, as shown in FIG. 15, a partitioning wall 15 is provided on the downstream side of an air flow deflection door 13 in the air flow in the duct 12, and defines a path communicating with a front side path 12a and a path communicating with a rear side path 12b. According to this embodiment too, the same advantages as in the first embodiment are obtained.

### Eighth Embodiment

In this embodiment, as shown in FIG. 16, a partitioning wall 15 is provided on the downstream side of an air flow deflection door 13 in the air flow in the duct 12, and defines a path communicating with a front side path 12a and a path communicating with a rear side path 12b. Further, two cantilever doors 134 and 135 are employed as the air flow deflection door 13. The same advantages as in the first embodiment are obtained by adjusting the ratio between the sectional area of the front side path 12a and the sectional area of the rear side path 12b using the two cantilever doors 134 and 135 respectively. Furthermore, according to this embodiment, the duct 12 can be fully closed by using the two cantilever doors 134 and 135, whereby a defroster/face door 34 can be omitted.

### Ninth Embodiment

In this embodiment, as shown in FIG. 17, two sliding doors 136 and 137 are employed as an air flow deflection door 13. The same advantages as in the first embodiment are obtained by adjusting the ratio between the sectional area of a front side path 12a and the sectional area of a rear side path 12b using the two sliding doors 136 and 137. Furthermore, according to this embodiment, the duct 12 can be fully closed by using the two sliding doors 136, whereby a defroster/face door 34 can be omitted.

### Tenth Embodiment

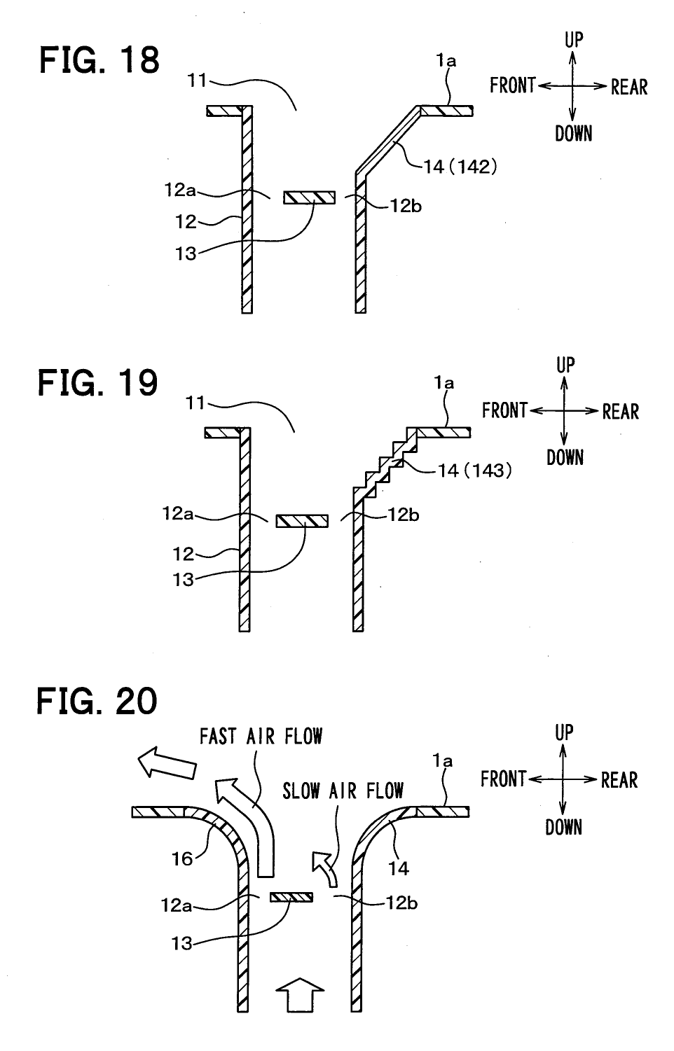

In this embodiment, as shown in FIG. 18, a guide wall 142 having a wall face with a tapered form is employed as a guide wall 14. The tapered form is a flat surface in which the path width of a duct 12 is gradually increased as extending toward the downstream side in the air flow. According to the guide wall 142 too, a high-speed air flow can be guided to the vehicle rear side along the wall face.

### Eleventh Embodiment

In this embodiment, as shown in FIG. 19, a guide wall 143 having a wall face with step portions is employed as a guide wall 14. According to the guide wall 143 too, a high-speed air flow can be guided to the vehicle rear side along the wall face. A guide wall is not limited to a curved form, as in this embodiment and the tenth embodiment, while the guide wall can curve a high-speed air flow along the wall face.

### Twelfth Embodiment

In this embodiment, as shown in FIG. 20, a duct 12 has a first guide wall 14 provided on the vehicle rear side of an air outlet 11, and a second guide wall 16 provided on the vehicle front side of the air outlet 11. The first guide wall 14 is the same as the guide wall 14 of the first embodiment. The second guide wall 16 guides a high-speed air flow to the vehicle front side along the wall face, and is of the same form as the first guide wall 14, except that the orientation in the front-rear direction differs from that of the first guide wall 14.

When the blowing mode is the defroster mode, while air is blown upward from the air outlet 11 in the first embodiment, according to this embodiment, air can be blown from the air outlet 11 to the vehicle front side. The forms of the first and second guide walls 14 and 16 may be a tapered form or a form having step portions, as in the tenth and eleventh embodiments.

### Thirteenth Embodiment

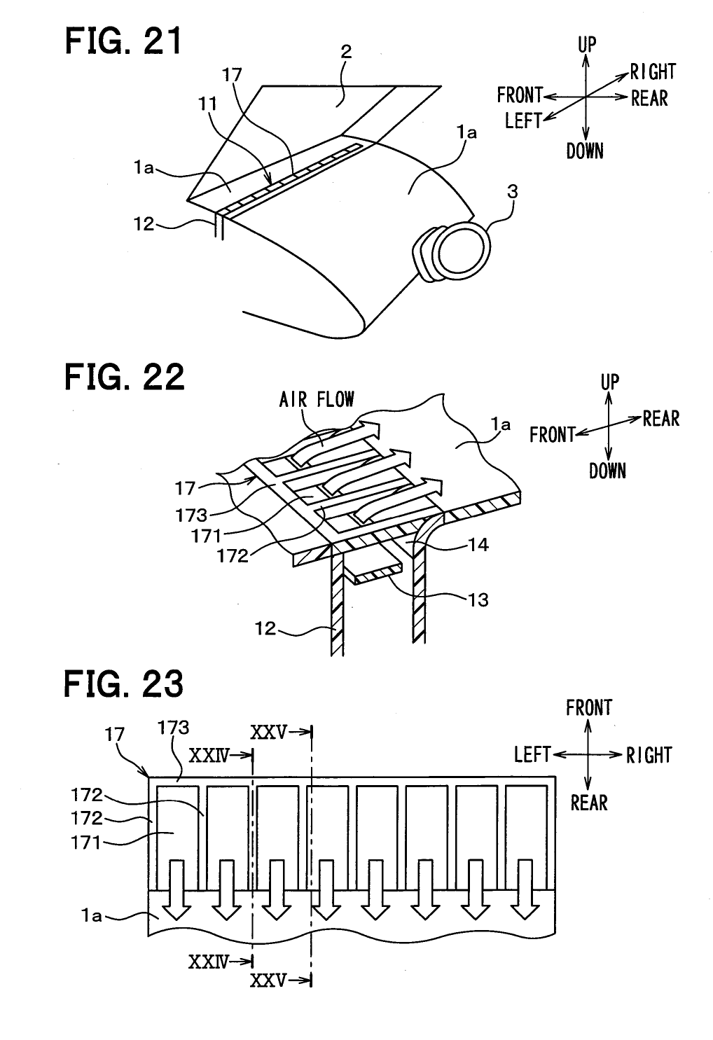

In this embodiment, a cover 17 is provided to cover an air outlet 11, as shown in FIG. 21. The air outlet 11 is of a form extending elongated in one direction, specifically the vehicle left-right direction, and is disposed across the front of the driver seat, where a steering wheel 3 is positioned, and the front of the front passenger seat, in the same way as in the first embodiment. The cover 17 is a foreign object infiltration prevention member that prevents infiltration of a foreign object from the air outlet 11.

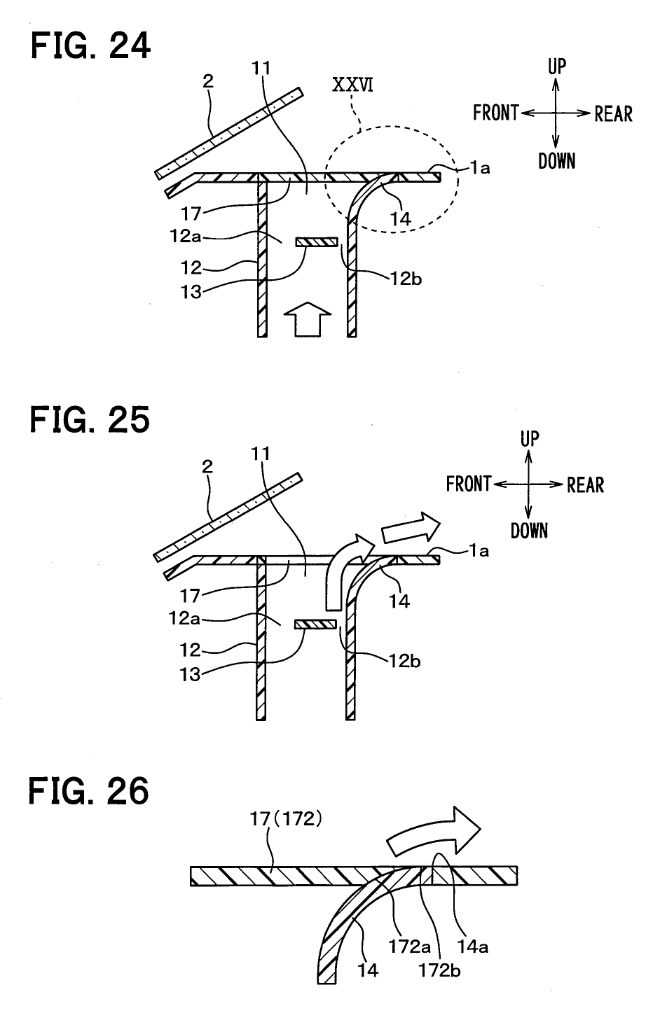

As shown in FIGS. 22 to 25, the cover 17 is a slit providing member that provides plural slits 171. Specifically, the cover 17 is of a comb form, and has multiple rod-form members 172 corresponding to multiple comb teeth, and a linking member 173 that links the multiple rod-form members 172. The multiple rod-form members 172 are parallel to the vehicle front-rear direction, while the linking member 173 is parallel to the vehicle left-right direction. The slit 171 is provided between neighboring rod-form members 172.

The slit 171 is an aperture portion long in one direction. The slit 171 extends parallel to the vehicle front-rear direction. In other words, the slit 171 extends in a direction perpendicular to the direction in which the air outlet 11 extends at length. Because of this, the slit 171 is of a form extending parallel to the direction in which air is blown from the air outlet 11 toward an occupant when in the face mode (refer to the blank arrows in FIGS. 22 and 23).

If a cover having a rod-form member parallel to the vehicle left-right direction and a slit parallel to the vehicle front-rear direction is provided on the air outlet 11, differing from this embodiment, the rod-form member exists throughout in the vehicle left-right direction. In this case, the orientation of air blown from the air outlet 11 is affected when in the face mode. That is, the angle of curve becomes small, because the high-speed air flow flows along the rod-form member extending in the vehicle left-right direction at a position through which the high-speed air flow passes, while the air flow flowing through the duct 12 curves along the guide wall 14 to the vehicle rear side when blown out of the air outlet 11.

As opposed to this, the cover 17 of this embodiment has the slit 171 with a shape extending parallel to the direction in which air is blown from the air outlet 11 toward an occupant, and no rod-form member exists at a position through which the high-speed air flow passes when the high-speed air flow passes through the slit 17. Therefore, infiltration of a foreign object from the air outlet can be prevented, while reducing the effect on the orientation of air blown from the air outlet 11, when in the face mode.

The width of the slit 171 is determined considering the size of a foreign object whose infiltration is to be prevented and the flow resistance when air passes through the slit 171. Also, in this embodiment, the direction in which the slit 171 extends is the vehicle front-rear direction, but this may equally well be another direction. When the direction in which air is blown from the air outlet 11 toward an occupant is a direction inclined with respect to the vehicle front-rear direction, the direction in which the slit 171 extends may be the inclined direction.

According to this embodiment, as shown in FIG. 26, an end portion 172a of the rod-form member 172 of the cover 17 is in contact with the guide wall 14. Consequently, the end portion 172a of the rod-form member 172 is a contact portion in contact with the guide wall 14. Further, an uppermost portion 172b of the contact portion 172a of the rod-form member 172 is in a position at the same height as an uppermost portion 14a of the guide wall 14. The uppermost portion 172b of the contact portion 172a of the rod-form member 172 is the downstream end portion of the contact portion 172a when an air flow following the guide wall 14 is provided. The uppermost portion 14a of the guide wall 14 is the downstream end portion of the guide wall 14 when an air flow following the guide wall 14 is provided.

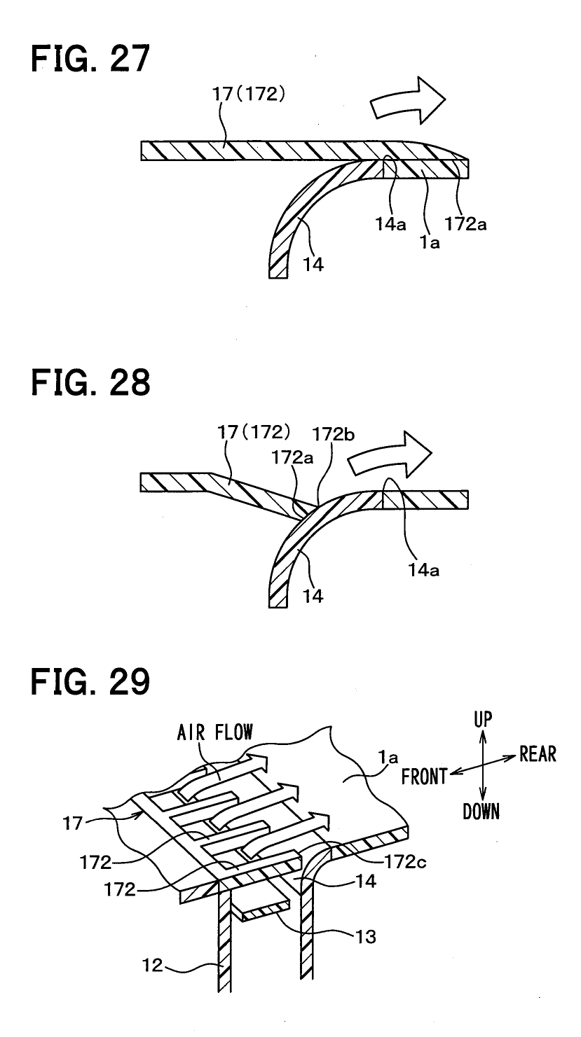

In the disclosure, as shown in FIG. 27, this embodiment may be modified in such a way that the end portion 172a of the cover 17 is positioned on the downstream side of the uppermost portion 14a of the guide wall 14. In this case, the end portion 172a of the cover 17 is brought into contact with an upper face 1a of an instrument panel, rather than with the guide wall 14. In this case, however, the cover 17 exists on the downstream side of the uppermost portion 14a of the guide wall 14 when an air flow following the guide wall 14 is provided. Because of this, the cover 17 affects the orientation of air blown from the air outlet 11 when in the face mode.

As opposed to this, as shown in FIG. 26, nothing affecting the orientation of air exists on the downstream side of the uppermost portion 14a of the guide wall 14 by setting the uppermost portion 172b of the contact portion 172a of the rod-form member 172 to be positioned at the same height as the uppermost portion 14a of the guide wall 14. Thus, the effect of the cover 17 on the orientation of air blown from the air outlet 11 can be reduced when in the face mode.

In this embodiment, the rod-form member 172 may be changed to a plate-form member while the cover 17 has the rod-form member 172.

### Fourteenth Embodiment

This embodiment is modified in the position of a contact portion 172a of a cover 17 with respect to the thirteenth embodiment. Specifically, as shown in FIG. 28, an uppermost portion 172b of the contact portion 172a of the cover 17 is in a position lower than an uppermost portion 14a of a guide wall 14.

Accordingly, as the uppermost portion 172b of the contact portion 172a of the cover 17 is in a position on the upstream side of the uppermost portion 14a of the guide wall 14, nothing affecting the orientation of air exists on the downstream side of the uppermost portion 14a of the guide wall 14. Therefore, the effect of the cover 17 on the orientation of air blown from an air outlet 11 can be reduced when in the face mode, in the same way as in the thirteenth embodiment.

### Fifteenth Embodiment

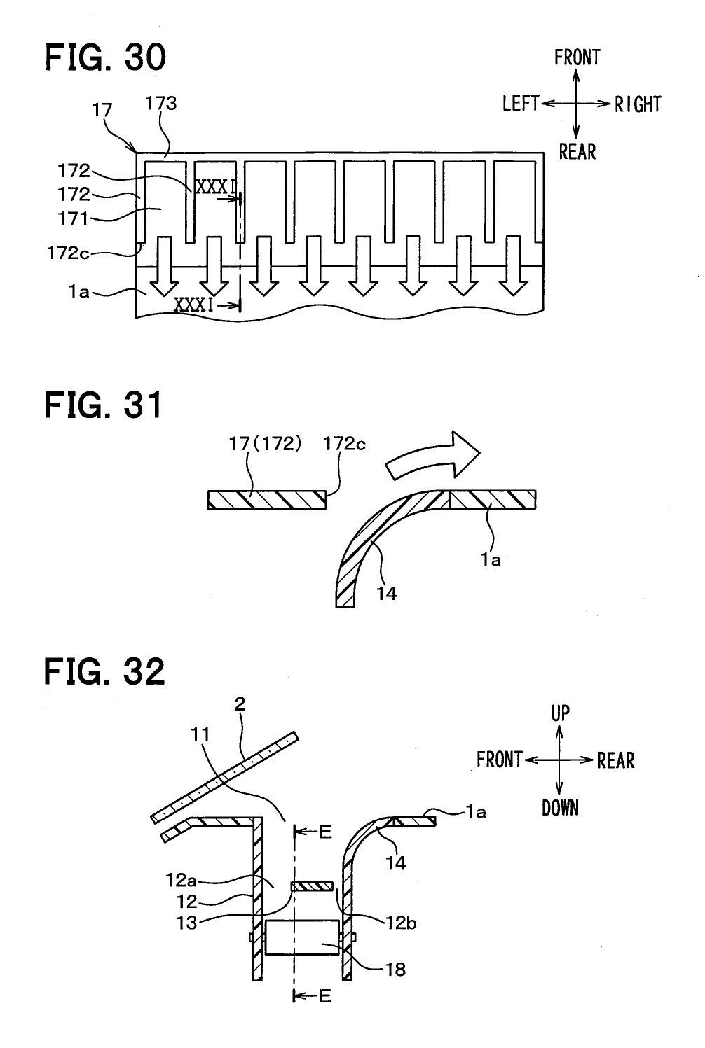

In this embodiment, as shown in FIGS. 29 to 31, a cover 17 is disposed to distance from a guide wall 14. That is, an end portion 172c of a rod-form member 172 of the cover 17 is not in contact with the guide wall 14, and a space is provided in the vicinity of the guide wall 14. Accordingly, as the cover 17 does not exist in the vicinity of the guide wall 14, there is no effect on the orientation of air blown from an air outlet 11 when in the face mode.

The cover 17 may exist on the upper side of an uppermost portion 14a of the guide wall 14 in a position distanced from the guide wall 14.

### Sixteenth Embodiment

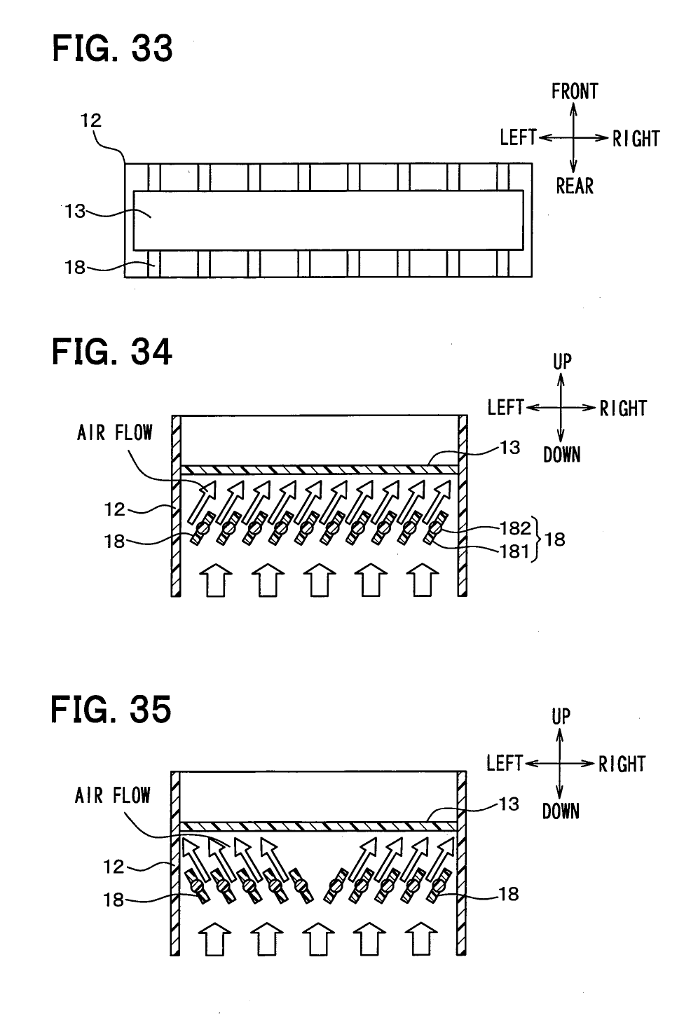

In this embodiment, as shown in FIGS. 32 to 36, a left-right direction adjusting door 18 is provided in the duct 12. The left-right direction adjusting door 18 is a blowing direction adjusting member that adjusts the direction of air blown from an air outlet 11 in the vehicle left-right direction by adjusting the orientation of an air flow flowing through the duct 12 in the vehicle left-right direction. The left-right direction adjusting door 18 also functions as an air speed distribution providing unit providing an air speed distribution in which the speed of air blown from a central portion of the air outlet 11 in the vehicle left-right direction and the speed of air blown from a side portion of the air outlet 11 on the outer side of the central portion differ from each other. The vehicle left-right direction corresponds to a direction perpendicular to a direction linking one side and the other side.

The left-right direction adjusting door 18 is disposed on the upstream side of an air flow deflection door 13 in the air flow in the duct 12. The air flow deflection door 13 is the same sliding door as in the first embodiment. In this embodiment, the left-right direction adjusting door 18 is configured of a butterfly door having a plate-form door main body portion 181 and a rotating shaft 182. The left-right direction adjusting door 18 is one of a plurality of left-right direction adjusting doors, which are disposed parallel to the air flow.

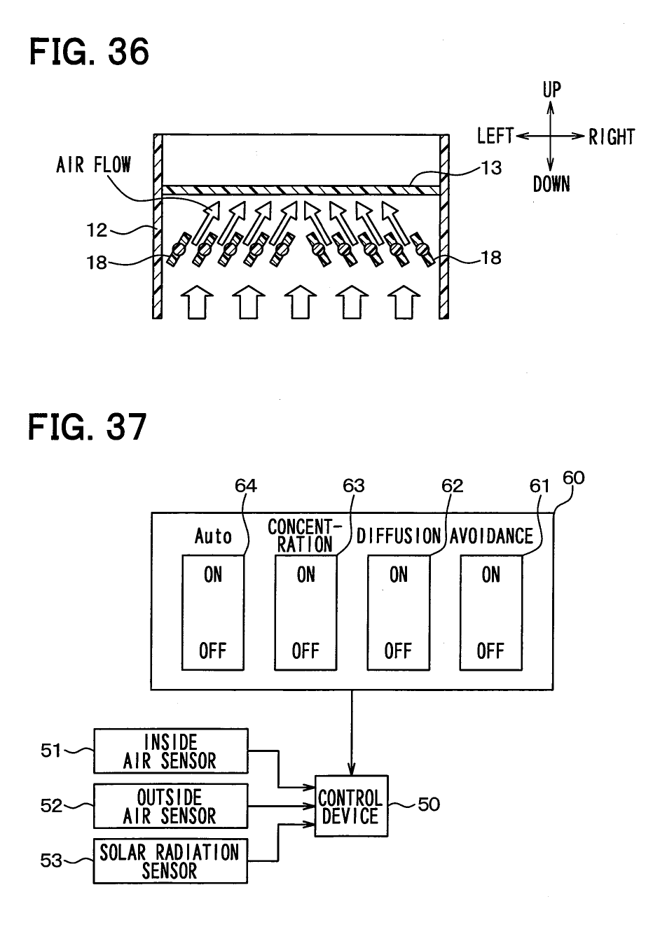

As shown in FIG. 34, the left-right direction adjusting doors 18 can all face in the same direction. As shown in FIGS. 35 and 36, of the left-right direction adjusting doors 18, a left-side group and a right-side group can face in differing directions. When the left-right direction adjusting doors 18 are set to have the orientation shown in FIG. 34, air can be blown from the air outlet 11 toward only one side in the left-right direction. When the left-right direction adjusting doors 18 are set to have the orientation shown in FIG. 35, air can be blown from the air outlet 11 in a V-form toward both sides in the left-right direction. When the left-right direction adjusting doors 18 are set to have the orientation shown in FIG. 36, air can be blown from the air outlet 11 concentrated in a central portion in the left-right direction. For example, when in the face mode, air blown from the air outlet 11 can pass the sides of the face of an occupant by adopting the orientation shown in FIG. 35, and air blown from the air outlet 11 can concentrate on only the face of an occupant by adopting the orientation shown in FIG. 36. Also, when in the defroster mode, air blown from the air outlet 11 can reach the whole surface of a windshield 2 by adopting one of the orientation shown in FIG. 35 or the orientation shown in FIG. 36, or by switching between the two orientations.

When in the face mode, air is blown from the air outlet 11 toward an occupant by a high-speed air flow provided by the air flow deflection door 13 flowing curved along a guide wall 14. If the left-right direction adjusting door 18 is provided on the downstream side of the air flow deflection door 13 in the air flow, differing from this embodiment, a high-speed air flow provided by the air flow deflection door 13 flows along the left-right direction adjusting door 18. In this case, the curve degree of air flowing curved along the guide wall 14 decreases.

Therefore, in this embodiment, the left-right direction adjusting door 18 is provided on the upstream side of the air flow deflection door 13 in the air flow, and the orientation of an air flow is adjusted in the left-right direction before a high-speed air flow is provided by the air flow deflection door 13. Because the high-speed air flow provided by the air flow deflection door 13 flows curved along the guide wall 14, the curve degree of air flowing curved along the guide wall 14 can be restricted from decreasing. In this embodiment, the left-right direction adjusting door 18 is configured of a butterfly door. Alternatively, the left-right direction adjusting door 18 may be configured of a cantilever door having a door main body portion and a rotating shaft.

Next, a specific description will be given of switching air direction mode using the left-right direction adjusting doors 18.

As shown in FIG. 37, selector switches 61, 62, 63, 64 for each air direction mode are provided on an operating panel 60, respectively, for an avoidance mode, a diffusion mode, a concentration mode, and an automatic (Auto) mode. Operating signals from the selector switches 61 to 64 of the air direction modes are input into a control device 50. The control device 50 causes the left-right direction adjusting doors 18 to operate in such a way that a selected air direction mode is executed, based on an input operating signal. In this way, an occupant can manually change the air direction mode by operating a selector switch.

The control device 50 is configured of a microcomputer and a peripheral circuit thereof, and controls operations of various kinds of instrument connected to the output side. In addition to the air direction mode selector switches 61 to 64, various kinds of air conditioning operating switch, such as a vehicle interior temperature setting switch that sets the vehicle interior temperature, are provided on the operating panel 60. Operating signals from the various kinds of air conditioning operating switch are input into the control device 50. Also, detection signals from a sensor group, such as an inside air sensor 51 that detects a vehicle interior temperature Tr, an outside air sensor 52 that detects an external air temperature Tam, and a solar radiation sensor 53 that detects an amount of sunlight Ts in the vehicle interior, are input into the control device 50.

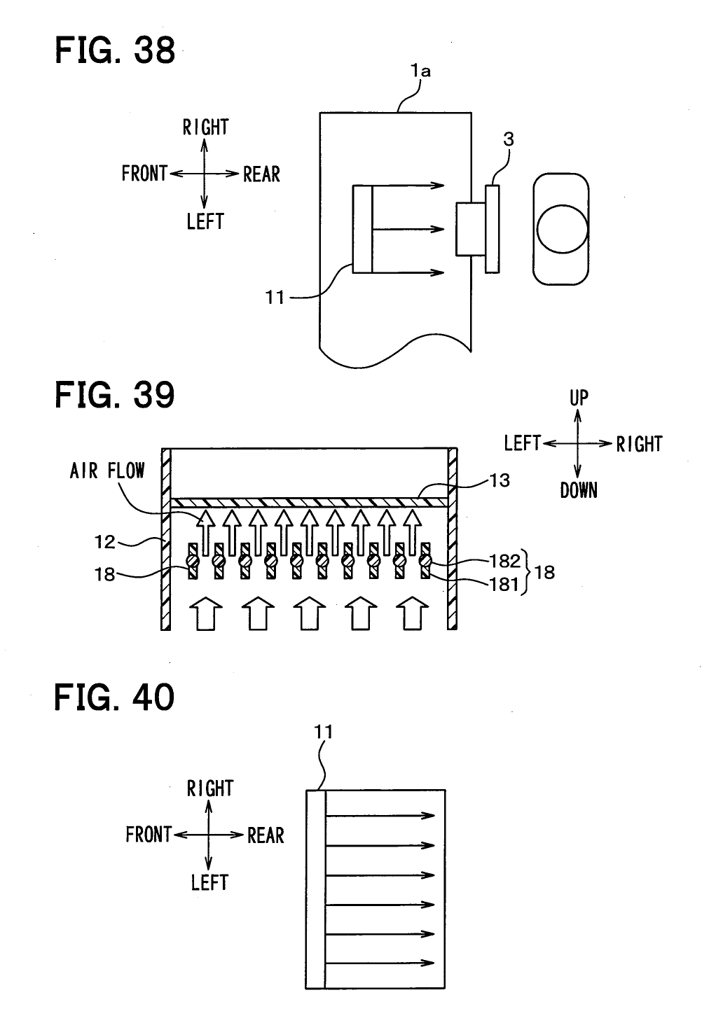

In this embodiment, as shown in FIG. 38, the air outlet 11 is provided to serve the driver seat and the front passenger seat. Hereafter, the air outlet 11 serving the driver seat will be described. The central position of the air outlet 11 in the left-right direction is the same as the central position of the seat in the left-right direction. The length in the left-right direction of the air outlet 11 is the same as the left-right length of the seat.

When all the air direction mode selector switches 61 to 64 are in an off-state, a normal mode is set. In the normal mode, as shown in FIG. 38, for example, as the face mode or a bi-level mode, air is blown from the air outlet 11 toward an occupant when in a blowing mode in which air is blown from the air outlet 11 rearward.

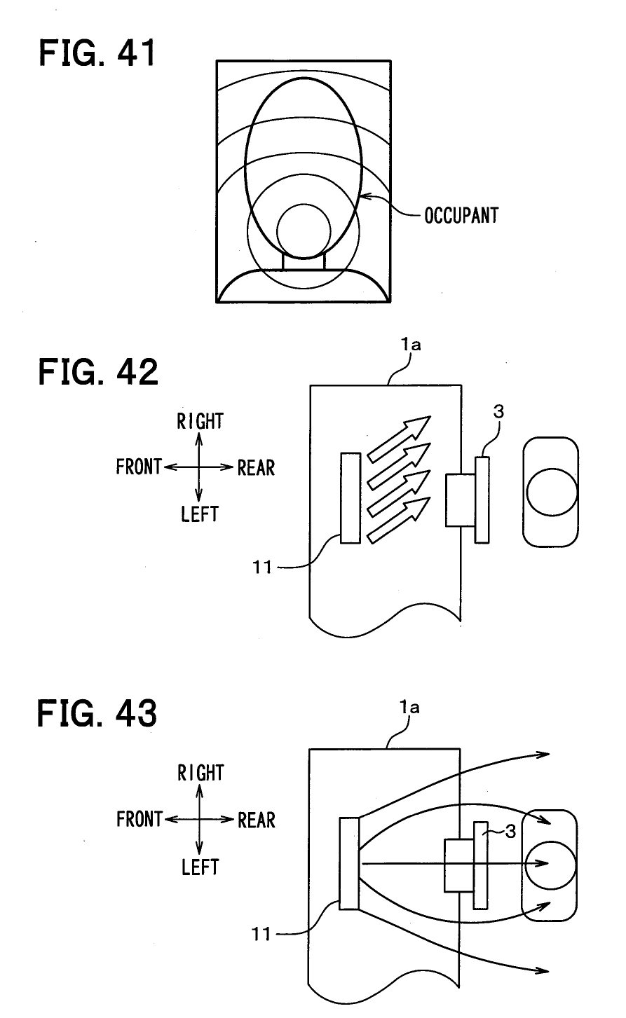

In the normal mode, as shown in FIG. 39, the left-right direction adjusting doors 18 are all parallel to the up-down direction. In this case, as shown in FIG. 40, air blown from the air outlet 11 has an air speed distribution in which the air speed is uniform in the left-right direction. As shown in FIG. 41, at the position of the occupant, the air speed distribution is set such that the air speed is the highest at the face (in particular, around the mouth) of the occupant. FIG. 41 shows the air speed distribution on the face of the occupant and in a region on the periphery of the face. Curved lines in FIG. 41 are boundary lines defining regions of equal air speed.

When the selector switch 61 of the avoidance mode is in an on-state, the avoidance mode is activated. As shown in FIG. 42, the avoidance mode is an air direction mode in which air blown from the air outlet 11 has an orientation that avoids an occupant when in a blowing mode in which air is blown from the air outlet 11 rearward, as in the face mode or the bi-level mode.

When the avoidance mode is selected, as shown in FIG. 34, all of the left-right direction adjusting doors 18 are inclined in such a way that downstream end portion thereof is on a window side (on the right side in the case of a vehicle with a steering on the right side). Because of this, air that has passed through the left-right direction adjusting doors 18 flows toward the vehicle right side. While maintaining this air flow orientation, the air flow curves to the vehicle rear side along the guide wall 14. Thus, as shown in FIG. 42, air is blown from the air outlet 11 toward the vehicle rear and to the vehicle right side of the occupant. When there is no occupant in the front passenger seat, air may be blown from the air outlet 11 toward only the front passenger seat.

The avoidance mode is selected when the occupant wishes to avoid air hitting the occupant directly. For example, in case where an occupant selects the avoidance mode when starting to cool down the vehicle in summer, heat mass (an amount of heat existing inside the air passage) inside the air passage can be disposed of without the heat mass being directed toward the occupant. Also, in case where an occupant selects the avoidance mode when the cooling operation is steady, conditioned air can be prevented from hitting the occupant directly.

The avoidance mode is also selected when the occupant wishes to feed conditioned air to the window side of the occupant. For example, when the temperature on a window side portion of the vehicle interior is higher than that of another space due to biased sunlight, cold air can be fed to the window side portion of the vehicle interior by selecting the avoidance mode.

When the selector switch 62 of the diffusion mode is in an on-state, the diffusion mode is activated. As shown in FIG. 43, the diffusion mode, for example, is an air direction mode in which air blown from the air outlet 11 is diffused within a range in the left-right direction when in a blowing mode in which air is blown from the air outlet 11 rearward, as in the face mode or the bi-level mode.

When the diffusion mode is selected, as shown in FIG. 35, the left-right direction adjusting doors 18 are controlled such that the downstream end portions of the left-side half of the left-right direction adjusting doors 18 are directed to the vehicle left side and that the downstream end portions of the right-side half of the left-right direction adjusting doors 18 are directed to the vehicle right side. Air that has passed through the left-right direction adjusting doors 18 flows in a V-form toward both the vehicle left and right sides. While maintaining this air flow orientation, the air flow curves to the vehicle rear side along the guide wall 14. Thus, as shown in FIG. 43, air is blown from the air outlet 11 toward the vehicle rear while diffusing to the vehicle left and right sides.

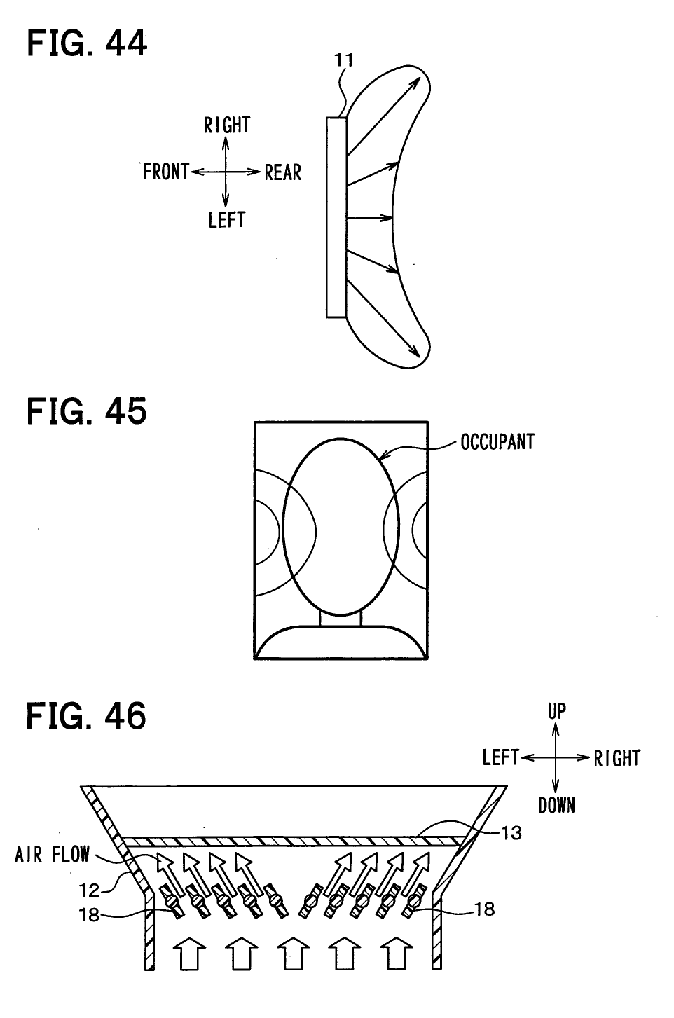

At this time, air blown from the air outlet 11 has an air speed distribution, as shown in FIG. 44, in which the speed of air blown from a central portion in the left-right direction is low, while the speed of air blown from the side portion on the outer side of the central portion is high. For example, as shown in FIG. 45, when the occupant selects the diffusion mode during a cooling operation, a gentle flow of air close to natural wind can be provided directly to the occupant. In comparison with the normal mode air speed distribution shown in FIG. 41, the air speed distribution shown in FIG. 45 has few boundary lines on the face of the occupant and in a region on the periphery thereof, indicating that there is little difference between air speed on the face of the occupant and on the periphery thereof. Also, the air speed at the face of the occupant is low compared with when in the normal mode, under a condition where the air feeding capacity of blower is the same.

If using air blown from the face air outlet 43 of the conventional device shown in FIG. 6, in order to provide the occupant with the same air conditioning feeling as in the diffusion mode of this embodiment, it is necessary to carry out indirect air conditioning whereby the blown air does not hit the occupant directly. In this case, air is blown from the face air outlet 43 avoiding the occupant, and the whole of the vehicle interior space has to be cooled.

As opposed to this, according to the diffusion mode of this embodiment, air blown from the air outlet 11 hits the occupant directly, such that the occupant can be cooled directly by the blown air. Because of this, according to the diffusion mode of this embodiment, a reduction in the capacity of the compressor configuring the refrigerating cycle, and a saving of energy, can be obtained in comparison with the indirect air conditioning of the convention device.

In this embodiment, as shown in FIG. 35, the side walls of the duct 12 on both the left and right sides are parallel to the vehicle up-down direction. Because of this, a part of air that has passed through the left-right direction adjusting doors 18 flows along the side walls of the duct 12 on the left and right sides. Therefore, as shown in FIG. 43, after air blown from the air outlet 11 flows in a V-form toward outer sides in the left-right direction, the air curves to inner sides in the left-right direction so as to surround the occupant. This has been confirmed by an experiment by the inventors.

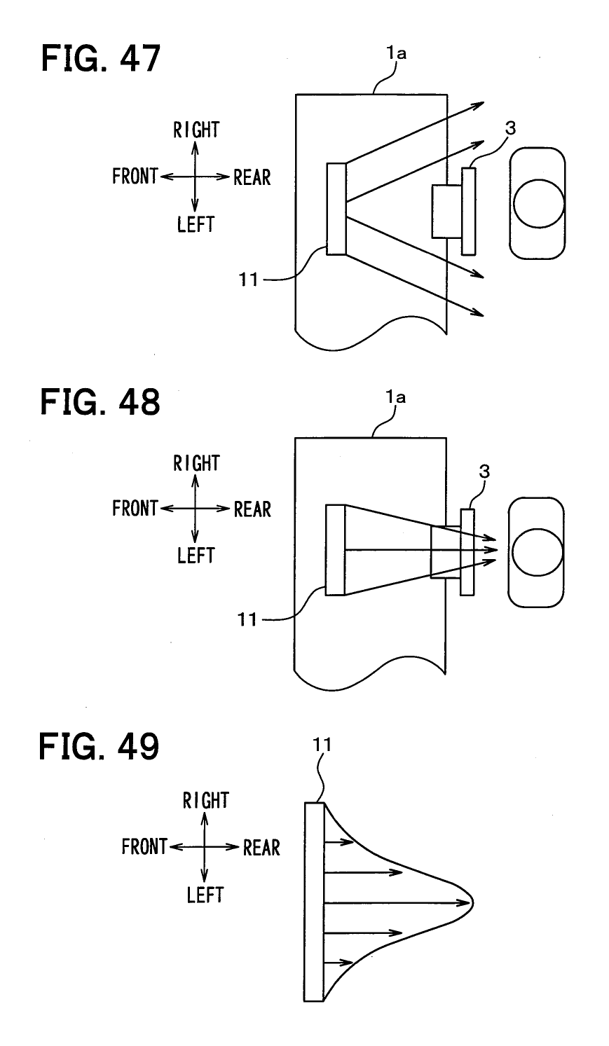

As shown in FIG. 46, the form of the duct 12 may be changed in such a way that the interval between the side walls of the duct 12 on the left and right sides gradually increases as extending toward the downstream side in the air flow, in an area downstream of the left-right direction adjusting doors 18 in the duct 12. In this case, as shown in FIG. 47, air is blown from the air outlet 11 to spread in a V-form to both the left and right sides. In this case too, the kind of air speed distribution shown in FIGS. 44 and 45 is provided.

The diffusion mode can also be used when, for example, disposing of heat mass inside the air passage when starting to cool down the vehicle in summer. Also, when using the diffusion mode in the defroster mode, the windshield can be cleared over a wide range.

When the selector switch 63 of the concentration mode is in an on-state, the concentration mode is activated. As shown in FIG. 48, the concentration mode, for example, is an air direction mode in which air blown from the air outlet 11 is concentrated to a part of the driver seat when in a blowing mode in which air is blown from the air outlet 11 toward the vehicle rear, as in the face mode or the bi-level mode. The part of the driver seat is, for example, a central portion of the driver seat in the left-right direction.

When the concentration mode is selected, as shown in FIG. 36, the left-right direction adjusting doors 18 are controlled such that the downstream end portions of the left-side half of the left-right direction adjusting doors 18 are directed to the vehicle right side, and the downstream end portions of the right-side half of the left-right direction adjusting doors 18 are directed to the vehicle left side. Thus, air that has passed through the left-right direction adjusting doors 18 flows in an inverted V-form. While maintaining this air flow orientation, the air flow curves to the vehicle rear side along the guide wall 14. Therefore, as shown in FIG. 48, air is blown from the air outlet 11 rearward while concentrated inwardly from the left and right sides.

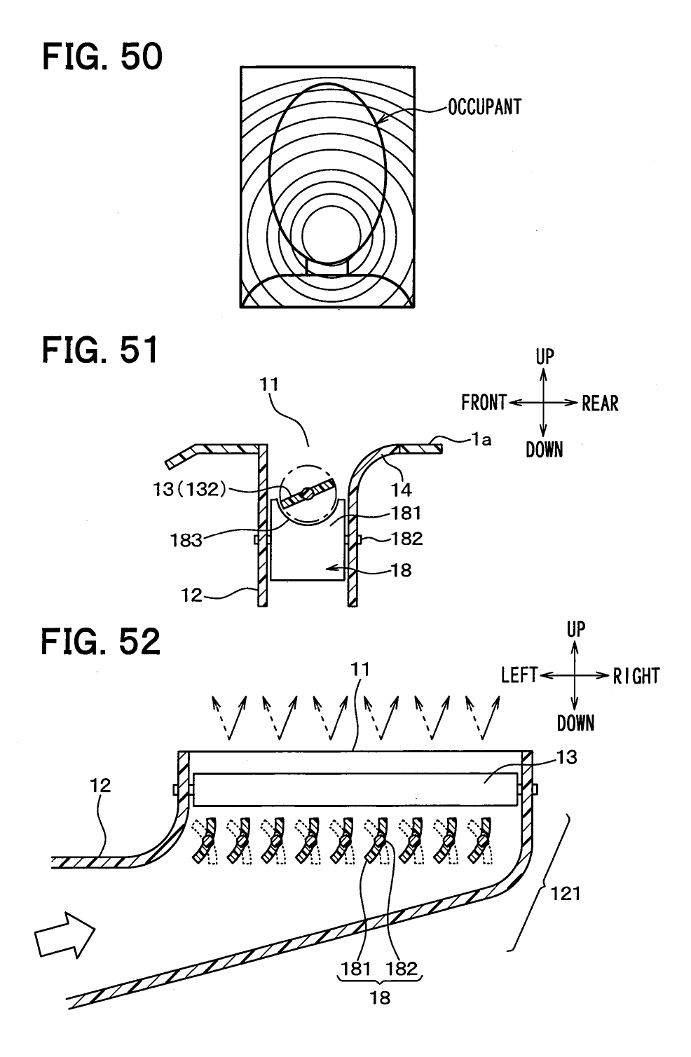

At this time, as shown in FIG. 49, air blown from the air outlet 11 has an air speed distribution in which the speed of air blown from a central portion in the left-right direction is high, and the speed of air blown from the outer side of the central portion is low. For example, when the occupant selects the concentration mode during a cooling operation, cold air can be provided at one spot to the occupant, as shown in FIG. 50. In the air speed distribution shown in FIG. 50, the air speed is the highest at the face of the occupant. In comparison with the air speed distribution at a normal mode shown in FIG. 41, there are a large number of boundary lines on the face of the occupant and in a region on the periphery thereof in FIG. 50, indicating that there is a large difference between air speed on the face of the occupant and on the periphery thereof.

If the speed of air blown from the air outlet 11 is uniform in the left-right direction, as in the normal mode shown in FIG. 40, ambient air on the left and right is mixed into air flow blown from the air outlet 11. Because of this, cold air blown from the air outlet 11 is liable to be affected by the temperature of the ambient air, and the temperature of the cold air rises before reaching the occupant.

As opposed to this, by adopting the air speed distribution shown in FIG. 49 as the air speed distribution of air blown from the air outlet 11, a high-speed air flow from a central portion of the air outlet 11 takes in a low-speed air flow from the outer side of the central portion of the air outlet 11, whereby the amount of ambient air taken in can be reduced. Therefore, the effect of ambient air on cold air blown from the air outlet 11 can be restricted, and a rise in temperature of the cold air before reaching the occupant can thus be restricted. As a result, the impact of the cooling can be increased when cooling down the vehicle in summer.

When the concentration mode is selected in the defroster mode, a part of the windshield can be cleared intensively. At this time, the concentration position to which the air is fed in the concentrated state may be shifted by controlling the orientation of the left-right direction adjusting doors 18 manually by the occupant or automatically by the control device 50.

When the selector switch 64 of the automatic mode is in an on-state, the control device 50 selects one of the avoidance mode, the diffusion mode, the concentration mode, or the normal mode as the air direction mode.

The control device 50 calculates a target blown air temperature TAO based on the vehicle interior temperature set by the occupant, the internal air temperature, the external air temperature, and the like, and determines the operating state of the various kinds of instrument in accordance with the target blown air temperature TAO.

As the air direction mode, the avoidance mode is selected at the start of cooling down. The concentration mode is selected after the start of cooling down. The diffusion mode is selected at a time of steady operation after cooling down. Heat mass inside the air passage can be disposed of without being directed toward the occupant at the start of cooling down. After the start of cooling down, cold air can hit the occupant at one spot. Gentle air close to natural wind can flow around the occupant at a time of steady operation.

“The start of cooling down” means a predetermined period immediately after the start of a cooling down control and before the blown air becomes cold air. “After the start of cooling down” means a period before the cooling down control finishes after the predetermined period is elapsed. “A time of steady operation” means a time of a cooling operation after the cooling down control finishes, for example, in which the difference between the target blown air temperature TAO and the internal air temperature is smaller than a predetermined value.

When the amount of sunlight detected by the solar radiation sensor 53 is large, the control device 50 may select the avoidance mode in order that air is blown from the air outlet 11 toward the window.

### Seventeenth Embodiment

This embodiment differs from the sixteenth embodiment in that an air flow deflection door 13 is a butterfly door 132 having a door main body portion and a rotating shaft, as shown in FIG. 51. Furthermore, in this embodiment, a depressed portion 183 is provided in one side of a door main body portion 181 of a left-right direction adjusting door 18 adjacent to the air flow deflection door 13. The depressed portion 183 is provided in order that the air flow deflection door 13 does not make contact when the air flow deflection door 13 rotates, and is of an arc form that follows the trajectory drawn by an end portion of the air flow deflection door 13 when the air flow deflection door 13 rotates.

The air flow deflection door 13 and the left-right direction adjusting door 18 have a positional relationship such that the end portion of the air flow deflection door 13 passes through the depressed portion 183 of the left-right direction adjusting door 18 when the air flow deflection door 13 rotates. By employing this kind of configuration, the distance between the air flow deflection door 13 and the left-right direction adjusting door 18 can be reduced, and a duct 12 can be reduced in size (downsized).

In this embodiment, the depressed portion 183 is of an arc form but, not being limited to this form. The depressed portion 183 may be of another form, such as quadrangular. In this embodiment, the left-right direction adjusting door 18 is configured of a butterfly door, but the left-right direction adjusting door 18 may be configured of a cantilever door having a door main body portion and a rotating shaft. In this case, the rotating shaft is positioned at an upstream end portion of the door main body portion, and a depressed portion is provided in one side of the door main body portion adjacent to the air flow deflection door 13. Thus, the same advantages as in this embodiment are achieved.

### Eighteenth Embodiment

In this embodiment, as shown in FIG. 52, a duct 12 has a curved portion 121 on an upstream side of an air outlet 11 in the air flow. Plural left-right direction adjusting door 18 are provided in the curved portion 121.

The curved portion 121 of the duct 12 is curved in such a way that the outer side (the right side in the drawing) is curved into a convex form in order to lead air flowing in a left-right direction (rightward in the drawing) upward. The passage sectional area of the duct 12 is reduced on the upstream side of the curved portion 121 in order that the amount of air after passing through the curved portion 121 is uniform in the left-right direction. The left-right direction adjusting door 18 is a butterfly door. A door main body portion 181 of the door is of a curved form to have a convex form on the same side as the curved portion 121 of the duct 12. In this embodiment, the left-right direction adjusting doors 18 are set such that the sizes of the door main body portions 181 are all the same. The left-right direction adjusting doors 18 are configured to be rotatable in order that all of the left-right direction adjusting doors 18 have the same orientation.

According to this embodiment, the left-right direction adjusting doors 18 are provided in the curved portion 121 of the duct 12. Therefore, the direction of air blown from the air outlet 11 can be adjusted in the vehicle left-right direction, and air that has passed through the curved portion 121 of the duct 12 can be made uniform in the left-right direction.

Furthermore, in this embodiment, the door main body portion 181 of the left-right direction adjusting door 18 has a form curved to have a convex form on the same side as the curved portion 121. If the door main body portion 181 is of a flat form, air passing the outer side of the door main body portion 181 becomes detached from the door main body portion 181. In this case, pressure loss occurs, and noise is generated. As opposed to this, according to this embodiment, an air flow following the form of the door main body portion 181 can be provided, whereby air passing the door main body portion 181 can be prevented from becoming detached from the door main body portion 181, such that noise generation can be prevented.

### Nineteenth Embodiment

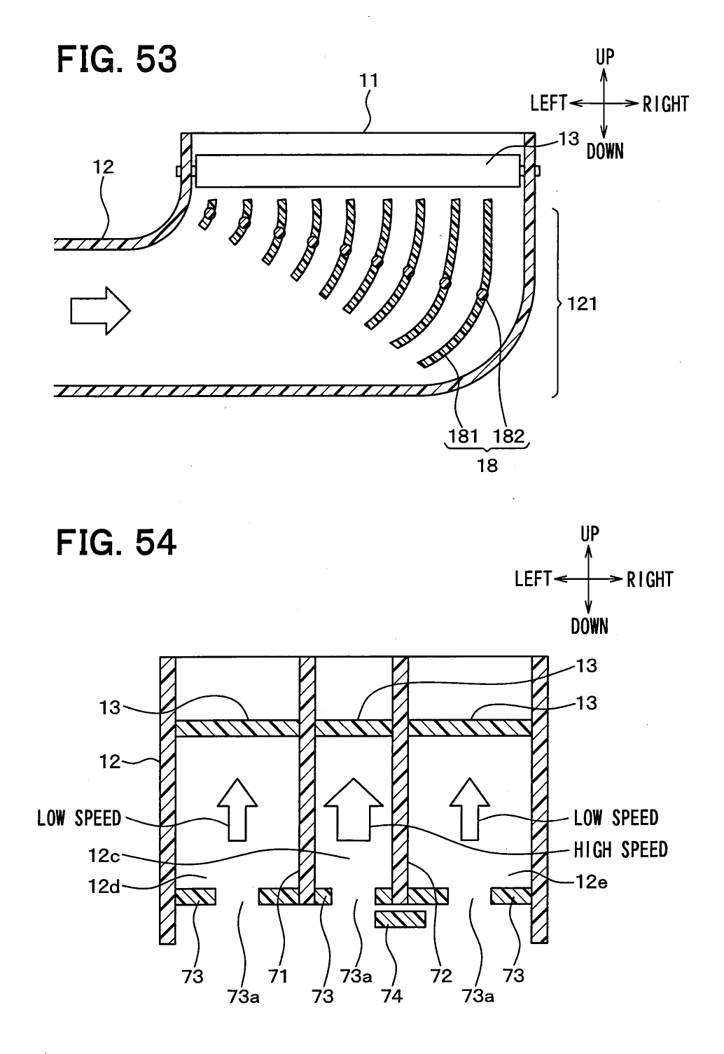

This embodiment differs from the eighteenth embodiment in that the form of a left-right direction adjusting door 18 provided in a curved portion 121 of a duct 12 becomes bigger, as the nearer the outer side of the curved portion 121, as shown in FIG. 53.

Specifically, the path sectional area of a region of the duct 12 on the upstream side of the curved portion 121 is uniform in the air flow direction. Further, a door main body portion 181 of the left-right direction adjusting doors 18 becomes bigger the nearer the outer side of the curved portion 121. Therefore, multiple air passages are provided in the curved portion 121 by the multiple left-right direction adjusting doors 18. Further, the air passages become longer the nearer the outer side of the curved portion 121, and pressure loss increases. As a result, air that has passed through the curved portion 121 of the duct 12 can be rendered uniform in the left-right direction.

In the eighteenth and nineteenth embodiments, the left-right direction adjusting door 18 is configured of a butterfly door, but the left-right direction adjusting door 18 may be configured of a cantilever door having a door main body portion and a rotating shaft.

### Twentieth Embodiment

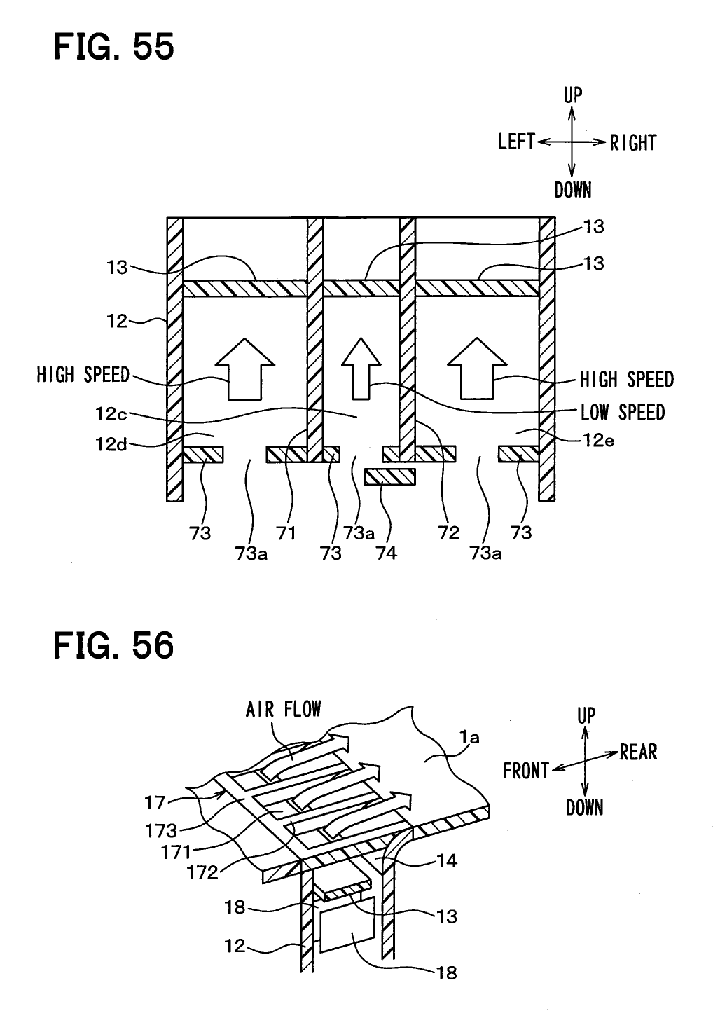

In this embodiment, as shown in FIGS. 54 and 55, partitioning walls 71 and 72 are provided to partitioning the interior of a duct 12 into three passages 12c, 12d, and 12e aligned in the left-right direction. The partitioning walls 71 and 72 are provided across the upstream side and the downstream side of an air flow deflection door 13 in the air flow. The partitioning walls 71 and 72 are disposed in such a way that the sectional area of a central passage 12c is small, while the sectional areas of a left-side passage 12d and a right-side passage 12e are large.

A wall 73 having an aperture portion 73a is provided on the entrance side of each passage 12c, 12d, and 12e. The open areas of the aperture portions 73a of the passages 12c, 12d, and 12e are all the same, and are smaller than the area of the central passage 12c. Furthermore, an adjusting door 74 that adjusts the open area of the aperture portion 73a is provided on the entrance side of the central passage 12c. The adjusting door 74 is a sliding door.

In this embodiment, the partitioning walls 71 and 72, the wall 73 having the aperture portion 73a, and the adjusting door 74 configure an air speed distribution providing unit providing an air speed distribution, in which the speed of air blown from a central portion of an air outlet 11 in the vehicle left-right direction and the speed of air blown from a side portion of the air outlet 11 on the outer side of the central portion are different from each other. Because of this, according to this embodiment too, the concentration mode and the diffusion mode can be realized in the same way as in the sixteenth embodiment.

That is, as shown in FIG. 54, the adjusting door 74 is positioned such that the aperture portion 73a is fully open. At this time, owing to the difference between the open area of the aperture portion 73a and the sectional areas of the passages 12c, 12d, and 12e, an air flow in the central passage 12c is of a high speed, while air flows in the left-side passage 12d and the right-side passage 12e are of a low speed. Because of this, the air blown from the air outlet 11 has an air speed distribution such that the speed of air blown from the central portion in the left-right direction is high, while the speed of air blown from the outer side of the central portion is low, and the concentration mode can be realized.

Meanwhile, the adjusting door 74 is positioned such that the open area of the aperture portion 73a is reduced, as shown in FIG. 55. At this time, the amount of air in the central passage 12c is less than the amounts of air in the left-side passage 12d and the right-side passage 12e. Therefore, an air flow in the central passage 12c is of a low speed, while air flows in the left-side passage 12d and the right-side passage 12e are of a high speed. Thus, the air blown from the air outlet 11 has an air speed distribution such that the speed of air blown from the central portion in the left-right direction is low, while the speed of air blown from the outer side of the central portion is high, and the diffusion mode can be realized.

### Other Embodiment

The disclosure is not limited to the embodiments, and may be modified as appropriate without departing from the scope of the disclosure, as described below.

In the embodiments, the air blowing device of the disclosure is applied to the air outlet 11 in the upper face 1a of the instrument panel 1. The air blowing device of the disclosure may be applied to an air outlet (foot air outlet) in the lower face of the instrument panel 1. In this case, the angle of air blown from the foot air outlet can be arbitrarily changed. Also, in the embodiments, the air blowing device of the disclosure is applied to an air conditioning device for a vehicle. The air blowing device of the disclosure may be applied to an air conditioning device of something other than a vehicle.

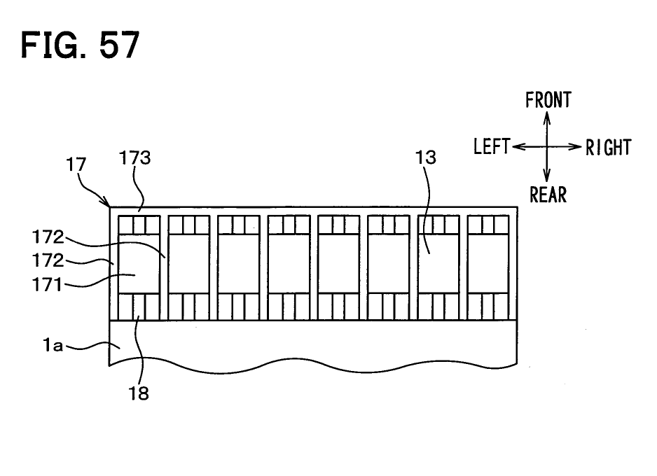

The embodiments are not unrelated to each other, and can be combined as appropriate except in cases in which combination is clearly not possible. For example, the twelfth embodiment can be combined with each of the first to eleventh embodiments. The thirteenth embodiment can be combined with each of the first to twelfth embodiments. Each of the sixteenth to twentieth embodiments can be combined with each of the first to fifteenth embodiments. Also, as shown in FIGS. 56 and 57, the cover 17 of the thirteenth embodiment and the left-right direction adjusting door 18 of the sixteenth embodiment can be used together.

Also, it goes without saying that in each of the embodiments, the components configuring the embodiment are not necessarily indispensable, except in cases in which a component is particularly noted as being indispensable, cases in which it can be supposed that a component is clearly indispensable in principle, and the like.

What is claimed is:

1. An air blowing device comprising:
an air outlet that blows air to a target space;
a duct communicated with the air outlet and having an air path inside; and
an air flow deflection member provided in the duct, wherein the air path has one side path on one side and other side path on the other side, the air flow deflection member being located between the one side path and the other side path in the duct,
the air flow deflection member is able to switch between a first state in which a high-speed air flow is provided in the one side path and a low-speed air flow is provided in the other side path by reducing a ratio of a sectional area of the one side path to be smaller than a ratio of a sectional area of the other side path and a second state in which an air flow differing from that of the first state is provided in the duct, and
a portion of the duct on the one side and adjacent to the air outlet has a guide wall to curve the high-speed air flow from the one side path along a wall surface of the guide wall.

2. The air blowing device according to claim 1, wherein the air flow deflection member is able to adjust a speed ratio between the high-speed air flow and the low-speed air flow by changing a ratio between the sectional area of the one side path and the sectional area of the other side path in the first state.

3. The air blowing device according to claim 1 further comprising: an air speed distribution providing unit provided in the duct to provide an air speed distribution in which a speed of air blown from a central portion of the air outlet and a speed of air blown from a side portion of the air outlet located on an outer side of the central portion are different from each other in a direction perpendicular to a direction linking the other side and the one side.

4. The air blowing device according to claim 1 further comprising: a plurality of a plate-form blowing direction adjusting member provided in the duct to adjust a blowing direction of air from the air outlet in a direction perpendicular to a direction linking the other side and the one side, wherein
the blowing direction adjusting member is disposed at the upstream side of the air flow deflection member.

5. The air blowing device according to claim 4, wherein the blowing direction adjusting member is able to provide an air speed distribution in which a speed of air blown from a central portion of the air outlet in a direction perpendicular to a direction linking the other side and the one side is low, and a speed of air blown from a side portion of the air outlet located on an outer side of the central portion is high.

6. The air blowing device according to claim 5, wherein the blowing direction adjusting member is configured in such a way that a flow of air passing through the blowing direction adjusting member in the duct has a V-form.

7. The air blowing device according to claim 4, wherein the blowing direction adjusting member is able to provide an air speed distribution in which a speed of air blown from a central portion of the air outlet in a direction perpendicular to a direction linking the other side and the one side is high, and a speed of air blown from a side portion of the air outlet located on an outer side of the central portion is low.

8. The air blowing device according to claim 7, wherein the blowing direction adjusting member is configured in such a way that a flow of air passing through the blowing direction adjusting member in the duct has an inverted V-form.

9. The air blowing device according to claim 1, wherein the air flow deflection member is a sliding door that is able to slide to the one side and the other side.

10. The air blowing device according to claim 1, wherein the air flow deflection member is a butterfly door.

11. The air blowing device according to claim 4, wherein the air flow deflection member is a butterfly door having a door main body portion and a rotating shaft,
the blowing direction adjusting member is a butterfly door or a cantilever door having a door main body portion and a rotating shaft,
the blowing direction adjusting member has a depressed portion provided in one side of the door main body portion adjacent to the air flow deflection member, and
the air flow deflection member and the blowing direction adjusting member have a positional relationship such that the air flow deflection member passes through the depressed portion when the air flow deflection member rotates.

12. The air blowing device according to claim 4, wherein the duct has a curved portion that curves into a convex form,
the blowing direction adjusting member is a butterfly door or a cantilever door having a door main body portion and a rotating shaft and is provided in the curved portion, and
the door main body portion of the blowing direction adjusting member has a curved form that curves into a convex form on the same side as the curved portion.

13. The air blowing device according to claim 1 further comprising: a slit providing member having a plurality of slits at the air outlet, wherein
the slit has a form extending parallel to an air blow-off direction in which air is blown from the air outlet toward an occupant when the air flow deflection member is in the first state.

14. The air blowing device according to claim 13, wherein the slit providing member has a contact portion that comes into contact with the guide wall, and
when an air flow following the guide wall is provided, a downstream end portion of the contact portion is at a position the same as or upstream side of a downstream end portion of the guide wall.

15. The air blowing device according to claim 13, wherein the slit providing member is distanced from the guide wall.

16. The air blowing device according to claim 1, wherein the air outlet is provided in an upper surface of an instrument panel of a vehicle, and
the one side and the other side are a rear side and a front side of the vehicle respectively.

17. The air blowing device according to claim 16, wherein the upper surface of the instrument panel is gradually lowered with respect to a horizontal plane as extending toward the rear side of the vehicle.

18. The air blowing device according to claim 16, wherein an uppermost portion of the guide wall is at a position higher than the upper surface of the instrument panel.

19. The air blowing device according to claim 18, wherein an uppermost portion of the guide wall is at a position higher than the upper surface of the instrument panel by being projected with respect to the upper surface of the instrument panel.

20. The air blowing device according to claim 1, wherein the air flow deflection member is able to switch between the first state and the second state in which a low-speed air flow is provided in the one side path and a high-speed air flow is provided in the other side path, and
the duct has a first guide wall, which is the guide wall, provided on the one side and adjacent to the air outlet, and a second guide wall provided on the other side and adjacent to the air outlet to curve the high-speed air flow from the other side path along a wall surface of the second guide wall.

21. The air blowing device according to claim 16, wherein
the one side path is configured to blow air toward at least an upper body of an occupant positioned on a rear side of the instrument panel,
the other side path is configured to blow air toward at least a windshield of the vehicle,
when the air flow deflection member is set to the first mode, a face mode is set such that air is blown from the one side path and the other side path toward the upper body of the occupant, and
when the air flow deflection member is set to the second mode, a defroster mode is set such that air is blown from the one side path and the other side path toward the windshield.
